(19) United States
(12) Patent Application Publication
(10) Pub. No.: US 2011/0320899 A1
(43) Pub. Date: Dec. 29, 2011

(54) COMMUNICATION SYSTEM, COMMUNICATION APPARATUS, RADIO BASE STATION, AND COMMUNICATION METHOD

(75) Inventor: Daisuke Toyama, Yokohama-shi (JP)

(73) Assignee: Kyocera Corporation, Kyoto-shi, Kyoto (JP)

(21) Appl. No.: 13/141,918

(22) PCT Filed: Dec. 24, 2009
(86) PCT No.: PCT/JP2009/071463

§ 371 Date: Jun. 23, 2011

(30) Foreign Application Priority Data
Dec. 24, 2008 (JP) 2008-327655
Feb. 25, 2009 (JP) 2009-043169

(51) Int. Cl. H04L 1/18; H04W 24/00

(52) U.S. Cl. 714/748

(57) ABSTRACT

A radio terminal generates a plurality of to-be-transmitted packets comprised of a code block and redundant bits for error detection, extracts transmission unit packets at the time of corresponding transmission from said plurality of to-be-transmitted packets, and links the transmission unit packets to generate and transmit a transmission packet. A radio base station measures and transmits, based on the redundant bits contained in each transmission unit packet, communication quality based on the redundant bits for each code block contained in each transmission unit packet. The radio terminal sets the transmission unit at the time of retransmission for each of the plurality of to-be-transmitted packets to a ratio according to the extent of degradation of communication quality for each code block, extracts the transmission unit packets at the time of the corresponding retransmission from the plurality of to-be-transmitted packets, and links the transmission unit packets to generate and retransmit the transmission packet.

### TECHNICAL FIELD

The present invention relates to: a communication system including two communication apparatuses, and allowing communications of packets, each including multiple code blocks obtained by dividing a bit sequence, between the two communication apparatuses; a communication apparatus and a radio base station in the communication system; and a communication method in the communication system.

### BACKGROUND ART

Hybrid automatic repeat request (HARQ) is employed for communications between a transmitter and a receiver, in some cases. The HARQ improves error detectability in the receiver by using automatic repeat request (ARQ) and an error detection using a forward error code (FEC) in combination.

Specifically, the transmitter transmits the same bit sequence multiple times. The receiver combines the same bit sequences received multiple times and determines the value of each bit based on the result of the combination. Thus, time diversity effect is obtained and the error detectability improves.

The transmitter may divide the bit sequence in units known as code blocks of a certain length, and transmit the resultant bit sequence if required for convenience in calculation processing of a decoder in the receiver.

For example, in the technique disclosed in Patent Literature 1, the transmitter divides an information bit sequence into multiple blocks. Then, the transmitter adds a CRC (Cyclic Redundancy Check) bit sequence that is an error detection code to each of the blocks to generate code blocks. Thereafter, the transmitter encodes and then transmits the code blocks. On the other hand, the receiver decodes each of the code blocks and detects an information bit sequence error included in the code blocks based on the CRC bit sequences included in the code blocks.

### CITATION LIST

### Patent Literature

Patent Literature 1: Japanese Patent Application Publication No. 2005-295192

### SUMMARY OF THE INVENTION

However, in the technique described in Patent Literature 1, the transmitter retransmits all the code blocks even when an error has occurred only in an information bit sequence of one of the code blocks, and thus efficient retransmission control cannot be achieved. More particularly, a radio base station as the transmitter retransmits all the code blocks even when an error has occurred only in the information bit sequence of one of the code blocks in one radio terminal as a receiver, and thus efficient retransmission control cannot be achieved.

In view of the above problem, an objective of the present invention is to provide a communication system, a communication apparatus, a radio base station, and a communication method that can achieve efficient retransmission control in accordance with the communication qualities of code blocks.

In order to solve the problems described above, the present invention has the following aspects. According to a first aspect of the present invention, there is provided a communication system (radio communication system 10) comprising a first communication apparatus (radio terminal 1) and a second communication apparatus (radio base station 2), and configured to allow communication of packets each including a plurality of code blocks obtained by dividing a bit sequence, the communication performed between the first communication apparatus and the second communication apparatus, wherein the first communication apparatus comprises: a to-be-transmitted packet generation unit (rate matching units 158-1, 158-2, and 158-3) configured to generate a plurality of to-be-transmitted packets each having the code block and redundant bits for error detection; a transmission unit setting unit (transmission unit setting unit 162) configured to set a transmission unit for each of the plurality of to-be-transmitted packets; a first transmission packet generation unit (rate matching units 158-1, 158-2, and 158-3, code block combiner 160) configured to extract a packet of the set transmission unit from each of the plurality of to-be-transmitted packets and combine the packets to generate a first transmission packet; and a packet transmitter (radio communication unit 106) configured to transmit the first transmission packet, the second communication apparatus comprises: a packet receiver (radio communication unit 206) configured to receive the first transmission packet; a communication quality measurement unit (communication quality measurement unit 258) configured to measure communication qualities of the code blocks respectively included in the packets of the transmission units in the received first transmission packet based on the redundant bits included in each of the packets of the transmission units; and a communication quality transmitter (radio communication unit 206) configured to transmit the measured communication qualities of the code blocks, and the first communication apparatus further comprises: a communication quality receiver (radio communication unit 106) configured to receive the communication qualities of the code blocks; a retransmission unit setting unit (transmission unit setting unit 162) configured to set a retransmission unit of each of the plurality of to-be-transmitted packets so that a ratio of the retransmission units is based on degradation levels of the received communication qualities of the code blocks; a second transmission packet generation unit (rate matching units 158-1, 158-2, and 158-3, code block combiner 160) configured to extract a packet of the set retransmission unit from each of the plurality of to-be-transmitted packets and combine the packets to generate a second transmission packet; and a packet retransmitter (radio communication unit 106) configured to transmit the second transmission packet.

In such a communication system, the first communication apparatus on the transmitter side extracts packets in the transmission units respectively from the multiple packets each including the code block and the redundant bits for error detection, and combines the packets to generate and transmit the first transmission packet. Meanwhile, the second communication apparatus on the receiver side measures and transmits the communication qualities of the code blocks in the received first transmission packet. Then, based on the communication qualities of the code blocks, the first communication apparatus sets the retransmission units of the code blocks. At this point, the first communication apparatus sets the retransmission units of the code blocks so that the ratio of the retransmission units is based on the degradation levels of the communication qualities of the code blocks. Thus, the retransmission units vary among the code blocks in accordance with the communication qualities of the code blocks, whereby efficient retransmission control can be achieved.

According to a second aspect of the present invention, there is provided a communication apparatus configured to communicate, with another communication apparatus, packets each including a plurality of code blocks obtained by dividing a bit sequence, the communication apparatus comprising: a to-be-transmitted packet generation unit configured to generate a plurality of to-be-transmitted packets each having the code block and redundant bits for error detection; a transmission unit setting unit configured to set a transmission unit for each of the plurality of to-be-transmitted packets; a first transmission packet generation unit configured to extract a packet of the set transmission unit from each of the plurality of to-be-transmitted packets and combine the packets to generate a first transmission packet; a packet transmitter configured to transmit the first transmission packet; a communication quality receiver configured to receive communication qualities of the code blocks from the other communication apparatus;

a retransmission unit setting unit configured to set a retransmission unit of each of the plurality of to-be-transmitted packets so that a ratio of the retransmission units is based on degradation levels of the received communication qualities of the code blocks; a second transmission packet generation unit configured to extract a packet of the set retransmission unit from each of the plurality of to-be-transmitted packets and combine the packets to generate a second transmission packet; and a packet retransmitter configured to transmit the second transmission packet.

Such a communication apparatus extracts packets in the transmission units respectively from the multiple packets each including the code block and the redundant bits for error detection, and combines the packets to generate and transmit the first transmission packet. Then, based on the communication qualities of the code blocks measured by a different communication apparatus, the communication apparatus sets the retransmission units of the code blocks. At this point, the first communication apparatus sets the retransmission units of the code blocks so that the ratio of the retransmission units is based on the degradation levels of the communication qualities of the code blocks. Thus, the retransmission units vary among the code blocks in accordance with the communication qualities of the code blocks, whereby efficient retransmission control can be achieved.

A third aspect of the present invention is summarized in that: the communication quality receiver receives a result of error detection on each of the code blocks in the other communication apparatus, and the retransmission unit setting unit sets zero as the retransmission unit of the to-be-transmitted packet including a code block where the result of the error detection indicates that there is no error, and sets a positive value as the retransmission unit of the to-be-transmitted packet including a code block where the result of the error detection indicates that there is an error.

A fourth aspect of the present invention is summarized in that: the communication quality receiver receives a likelihood of each of the code blocks in the other communication apparatus, and the retransmission unit setting unit sets the retransmission units of the to-be-transmitted packets so that the ratio of the retransmission units is based on the inverse of the likelihoods.

A fifth aspect of the present invention is summarized in that: the communication apparatus further comprising a notification receiver (radio communication unit 106) configured to receive an abnormal notification or a normal notification from the other communication apparatus, the abnormal notification indicating that the code block is not normally received, the normal notification indicating that the code block is normally received, wherein the packet retransmitter transmits the second transmission packet when the abnormal notification is received or no normal notification is received within a predetermined period of time after the transmission performed by the packet transmitter.

According to a sixth aspect of the present invention, there is provided a communication apparatus configured to communicate, with another communication apparatus, packets each including a plurality of code blocks obtained by dividing a bit sequence, the communication apparatus comprising: a packet receiver configured to receive a transmission packet in the case where the other communication apparatus transmits the transmission packet, the transmission packet generated by the other communication apparatus by: extracting a packet of a predetermined transmission unit from each of a plurality of to-be-transmitted packets each including the code block and redundant bits for error detection; and combining the packets of the predetermined transmission units; a communication quality measurement unit configured to measure communication qualities of the code blocks respectively included in the packets of the predetermined transmission units based on the redundant bits respectively included in the packets of the predetermined transmission units in the received transmission packet; and a communication quality transmitter configured to transmit the measured communication qualities of the code blocks.

Such a communication apparatus measures and transmits the communication qualities of the code blocks in the transmission packet received from a different communication apparatus. Hence, based on the communication qualities of the code blocks, the different communication apparatus can set the retransmission units of the code blocks. At this point, the different communication apparatus sets the retransmission units of the code blocks so that the ratio of the retransmission units is based on the degradation levels of the communication qualities of the code blocks. Thus, the retransmission units vary among the code blocks in accordance with the communication qualities of the code blocks, whereby efficient retransmission control can be achieved.

A seventh aspect of the present invention is summarized in that: the communication quality measurement unit acquires a result of error detection on each of the code blocks.

An eighth aspect of the present invention is summarized in that: the communication quality measurement unit acquires a likelihood of each of the code blocks.

A ninth aspect of the present invention is summarized in that: the communication apparatus further comprising a notification transmitter (communication quality measurement unit 258, radio communication unit 206) configured to transmit a notification indicating that the code blocks are not normally received or a notification indicating that the code blocks are normally received, based on the measured communication qualities of the code blocks.

According to a tenth aspect of the present invention, there is provided a communication method in a communication system including a first communication apparatus and a second communication apparatus, and allowing communication of packets each including a plurality of code blocks obtained by dividing a bit sequence, the communication performed between the first communication apparatus and the second communication apparatus, the communication method comprising the steps of: generating, by the first communication apparatus, a plurality of to-be-transmitted packets each having the code block and redundant bits for error detection; setting, by the first communication apparatus, a transmission unit for each of the plurality of to-be-transmitted packets; extracting, by the first communication apparatus, a packet of the set transmission unit from each of the plurality of to-be-transmitted packets and combining the packets to generate a first transmission packet; transmitting the first transmission packet by the first communication apparatus; receiving the first transmission packet by the second communication apparatus; measuring, by the second communication apparatus, communication qualities of the code blocks included in each of the packets of the transmission units in the received first transmission packet based on the redundant bits included in the packet of the transmission unit; transmitting the measured communication qualities of the code blocks by the second communication apparatus; receiving the communication qualities of the code blocks by the first communication apparatus; setting, by the first communication apparatus, a retransmission unit of each of the plurality of to-be-transmitted packets so that a ratio of the retransmission units is based on degradation levels of the received communication qualities of the code blocks; extracting, by the first communication apparatus, a packet of the set retransmission unit from each of the plurality of to-be-transmitted packets and combining the packets to generate a second transmission packet; and transmitting the second transmission packet by the first communication apparatus.

According to the present invention, it is possible to achieve efficient retransmission control in accordance with the communication qualities of the code blocks.

According to an eleventh aspect of the present invention, there is provided a communication system (radio communication system 1010) comprising a radio base station (radio base station 1001) and a plurality of radio terminals (radio terminals 1002A to 1002C), and configured to simultaneously send the plurality of radio terminals packets each including a plurality of code blocks obtained by dividing a bit sequence indicating the same information from the radio base station, wherein the radio base station comprises: a to-be-transmitted packet generation unit (rate matching units 1158-1, 1158-2, and 1158-3) configured to generate a plurality of to-be-transmitted packets each having the code block and redundant bits for error detection; a transmission unit setting unit (transmission unit setting unit 1162) configured to set a transmission unit for each of the plurality of to-be-transmitted packets; a first transmission packet generation unit (rate matching units 1158-1, 1158-2, and 1158-3, code block combiner 1160) configured to extract a packet of the set transmission unit from each of the plurality of to-be-transmitted packets and combine the packets to generate a first transmission packet; and a packet transmitter (radio communication unit 1106) configured to transmit the first transmission packet to the plurality of radio terminals, the plurality of radio terminals each comprises: a packet receiver (radio communication unit 1206) configured to receive the first transmission packet from the radio base station; a communication quality measurement unit (communication quality measurement unit 1258) configured to measure communication qualities of the code blocks respectively included in the packets of the transmission units in the received first transmission packet based on the redundant bits respectively included in the packets of the transmission units; and a communication quality transmitter (radio communication unit 1206) configured to transmit the measured communication qualities of the code blocks to the radio base station, the radio base station comprises: a communication quality receiver (radio communication unit 1106) configured to receive the communication qualities of the code blocks from the plurality of radio terminals; a retransmission unit setting unit (transmission unit setting unit 1162) configured to set a retransmission unit of each of the plurality of to-be-transmitted packets so that a ratio of the retransmission units is based on degradation levels of the communication qualities of the code blocks received from the plurality of radio terminals; a second transmission packet generation unit (rate matching units 1158-1, 1158-2, and 1158-3, code block combiner 1160) configured to extract a packet of the set retransmission unit from each of the plurality of to-be-transmitted packets and combine the packets to generate a second transmission packet; and a packet retransmitter (radio communication unit 1106) configured to transmit the second transmission packet to the plurality of radio terminals, and the plurality of radio terminals each further comprise a retransmission packet receiver (radio communication unit 1206) configured to receive the second transmission packet from the radio base station.

In such a communication system, the radio base station on the transmitter side extracts packets of the transmission units respectively from the multiple packets each including the code block and the redundant bits for error detection, and combines the packets to generate the first transmission packet and transmits the first transmission packet to the multiple radio terminals simultaneously. Meanwhile, the multiple radio terminals on the receiver side measures and transmits the communication qualities of the code blocks in the received first transmission packet. Then, based on the communication qualities of the code blocks measured by the multiple radio terminals, the radio base station sets the retransmission units of the code blocks. At this point, the radio base station sets the retransmission units of the code blocks so that the ratio of the retransmission units is based on the degradation levels of the communication qualities of the code blocks measured by the multiple radio terminals. Thus, the retransmission units vary among the code blocks in accordance with the communication qualities of the code blocks measured by the multiple radio terminals, whereby efficient retransmission control can be achieved.

According to a twelfth aspect of the present invention, there is provided a radio base station configured to simultaneously send a plurality of radio terminals packets each including a plurality of code blocks obtained by dividing a bit sequence of the same information, the radio base station comprising: a to-be-transmitted packet generation unit configured to generate a plurality of to-be-transmitted packets each having the code block and redundant bits for error detection; a transmission unit setting unit configured to set a transmission unit for each of the plurality of to-be-transmitted packets; a first transmission packet generation unit configured to extract a packet of the set transmission unit from each of the plurality of to-be-transmitted packets and combine the packets to generate a first transmission packet; a packet transmitter configured to transmit the first transmission packet to the plurality of radio terminals; a communication quality receiver configured to receive communication qualities of the code blocks from the plurality of radio terminals; a retransmission unit setting unit configured to set a retransmission unit of each of the plurality of to-be-transmitted packets so that a ratio of the retransmission units is based on degradation levels of the communication qualities of the code blocks received from the plurality of radio terminals; a second transmission packet generation unit configured to extract a packet of the set retransmission unit from each of the plurality of to-be-transmitted packets and combine the packets to generate a second transmission packet; and a packet retransmitter configured to transmit the second transmission packet to the plurality of radio terminals.

Such a radio base station extracts packets of the transmission units respectively from the multiple packets each including the code block and the redundant bits for error detection, and combines the packets to generate the first transmission packet and transmits the first transmission packet to the multiple radio terminals simultaneously. Then, based on the communication qualities of the code blocks measured by the multiple radio terminals, the radio base station sets the retransmission units of the code blocks. At this point, the radio base station sets the retransmission units of the code blocks so that the ratio of the retransmission units is based on the degradation levels of the communication qualities of the code blocks measured by the multiple radio terminals. Thus, the retransmission units vary among the code blocks in accordance with the communication qualities of the code blocks measured by the multiple radio terminals, whereby efficient retransmission control can be achieved.

A thirteenth aspect of the present invention is according to the second aspect and is summarized in that: the communication quality receiver receives a result of error detection on each of the code blocks in the plurality of radio terminals, and the retransmission unit setting unit sets a positive value as the retransmission unit of the to-be-transmitted packet including the code block where the result of the error detection indicating that there is an error in at least one of the plurality of radio terminals.

A fourteenth aspect of the present invention is according to the second or third aspect and is summarized in that: the communication quality receiver receives a result of error detection on each of the code blocks in the plurality of radio terminals, and the retransmission unit setting unit sets a positive value as the retransmission unit of the to-be-transmitted packet including the code block where the result of the error detection indicating that there is an error in at least one of the plurality of radio terminals.

A fifteenth aspect of the present invention is summarized in that: the communication quality receiver receives a likelihood of each of the code blocks in the plurality of radio terminals, and the retransmission unit setting unit sets a positive value as the retransmission unit of the to-be-transmitted packet including the code block where the likelihood is smaller than a predetermined value in at least one of the plurality of radio terminals.

A sixteenth aspect of the present invention is according to one of the second to fifth aspects and is summarized in that: the radio base station further comprising a notification receiver (radio communication unit 1106) configured to receive an abnormal notification or a normal notification from each of the plurality of radio terminals, the abnormal notification indicating that not all the code blocks in the first transmission packets are normally received, the normal notification indicating that all the code blocks in the first transmission packets are normally received, wherein the packet retransmitter transmits the second transmission packet when the abnormal notification is received from any one of the plurality of radio terminals, or the normal notification is not received from any one of the plurality of radio terminals within a predetermined period of time after the transmission performed by the packet transmitter.

A seventeenth aspect of the present invention is according to the sixth aspect and is summarized in that: the radio base station sets destinations of the second transmission packet when the normal notification is received from any one of the plurality of radio terminals, by setting as the destinations the radio terminals other than the radio terminal that has transmitted the normal notification.

Such a radio base station excludes the radio terminal that has normally received all the code blocks in the first transmission packet from the destination of the second transmission packet. Thus, no second transmission packet is transmitted to a radio terminal requiring no retransmission, whereby unnecessary receiving process can be prevented from occurring in the radio terminal.

According to an eighteenth aspect of the present invention, there is provided a communication method in a communication system including a radio base station and a plurality of radio terminals, and configured to simultaneously send the plurality of radio terminals packets each including a plurality of code blocks obtained by dividing a bit sequence indicating the same information from the radio base station, the communication method comprising the steps of: generating, by the radio base station, a plurality of tobe-transmitted packets each having the code block and redundant bits for error detection; setting, by the radio base station, a transmission unit for each of the plurality of to-be-transmitted packets; extracting, by the radio base station, a packet of the set transmission unit from each of the plurality of to-be-transmitted packets and combining the packets to generate a first transmission packet; transmitting the first transmission packet to the plurality of radio terminals by the radio base station; receiving the first transmission packet from the radio base station by the plurality of radio terminals; measuring, by the plurality of radio terminals, communication qualities of the code blocks respectively included in the packets of the transmission units in the received first transmission packet based on the redundant bits included in each of the packets of the transmission units; transmitting the measured communication qualities of the code blocks to the radio base station by the plurality of radio terminals; receiving the communication qualities of the code blocks from the plurality of radio terminals by the radio base station; setting, by the radio base station, a retransmission unit of each of the plurality of to-be-transmitted packets so that a ratio of the retransmission units is based on degradation levels of the communication qualities of the code blocks received from the plurality of radio terminals; extracting, by the radio base station, a packet of the set retransmission unit from each of the plurality of to-be-transmitted packets and combining the packets to generate a second transmission packet; transmitting the second transmission packet to the plurality of radio terminals by the radio base station; and receiving the second transmission packet from the radio base station by the plurality of radio terminals.

According to the present invention, it is possible to achieve efficient retransmission control in accordance with the communication qualities of the code blocks among multiple radio terminals.

### BRIEF DESCRIPTION OF THE DRAWINGS

FIG. 1 is an overall schematic configuration view of a communication system according to a first embodiment of the present invention.

FIG. 2 is a schematic configuration view of a radio terminal according to the first embodiment of the present invention.

FIG. 3 is a functional block configuration diagram of a controller in the radio terminal according to the first embodiment of the present invention.

FIG. 4 is an overall schematic configuration view of a radio base station according to a first embodiment of the present invention.

FIG. 5 is a functional block configuration diagram of a controller in the radio base station according to the first embodiment of the present invention.

FIG. 6 is a sequence diagram showing operations of the radio communication system according to the first embodiment of the present invention.

FIG. 7 is a diagram showing a HARQ packet generation step according to the first embodiment of the present invention.

FIG. 8 is a diagram showing an example of CRC check according to the first embodiment of the present invention.

FIG. 9 is a diagram showing a structure of a retransmission HARQ packet according to the first embodiment of the present invention.

FIG. 10 is a diagram showing an example of CRC recheck according to the first embodiment of the present invention.

FIG. 11 is a diagram showing an example of likelihood detection according to the other embodiment of the present invention.

FIG. 12 is a diagram showing another structure of a retransmission HARQ packet according to the other embodiment of the present invention.

FIG. 13 is a diagram showing an example of likelihood redetection according to the other embodiment of the present invention.

FIG. 14 is an overall schematic configuration view of a communication system according to a second embodiment of the present invention.

FIG. 15 is a schematic configuration view of a radio terminal according to the second embodiment of the present invention.

FIG. 16 is a functional block configuration diagram of a controller in the radio terminal according to the second embodiment of the present invention.

FIG. 17 is an overall schematic configuration view of a radio terminal according to a second embodiment of the present invention.

FIG. 18 is a functional block configuration diagram of a controller in the radio terminal according to the second embodiment of the present invention.

FIG. 19 is a sequence diagram showing operations of the radio communication system according to the second embodiment of the present invention.

FIG. 20 is a diagram showing a HARQ packet generation step according to the second embodiment of the present invention.

FIG. 21 is a diagram showing an example of CRC check according to the second embodiment of the present invention.

FIG. 22 is a diagram showing a structure of a retransmission HARQ packet according to the second embodiment of the present invention.

FIG. 23 is a diagram showing an example of CRC recheck according to the second embodiment of the present invention.

FIG. 24 is a diagram showing an example of likelihood detection according to the other embodiment of the present invention.

FIG. 25 is a diagram showing a structure of a retransmission HARQ packet according to the other embodiment of the present invention.

FIG. 26 is a diagram showing an example of likelihood redetection according to the other embodiment of the present invention.

### DESCRIPTION OF EMBODIMENTS

### First Embodiment

Now, a first embodiment of the present invention is described with reference to the drawings. Specifically, description is given of (1) Configuration of Communication System, (2) Operation in Communication System, (3) Advantageous Effect, and (4) Other Embodiment. In the description of the drawings for the first embodiment below, the same or similar components are given the same or similar reference numerals.

### (1) Configuration of Communication System

First of all, the configuration of a communication system according to the first embodiment of the present invention is described in the order of (1.1) Overall Schematic Configuration of Communication System, and (1.2) Configuration of Communication Apparatus.

(1.1) Overall Schematic Configuration of Communication System

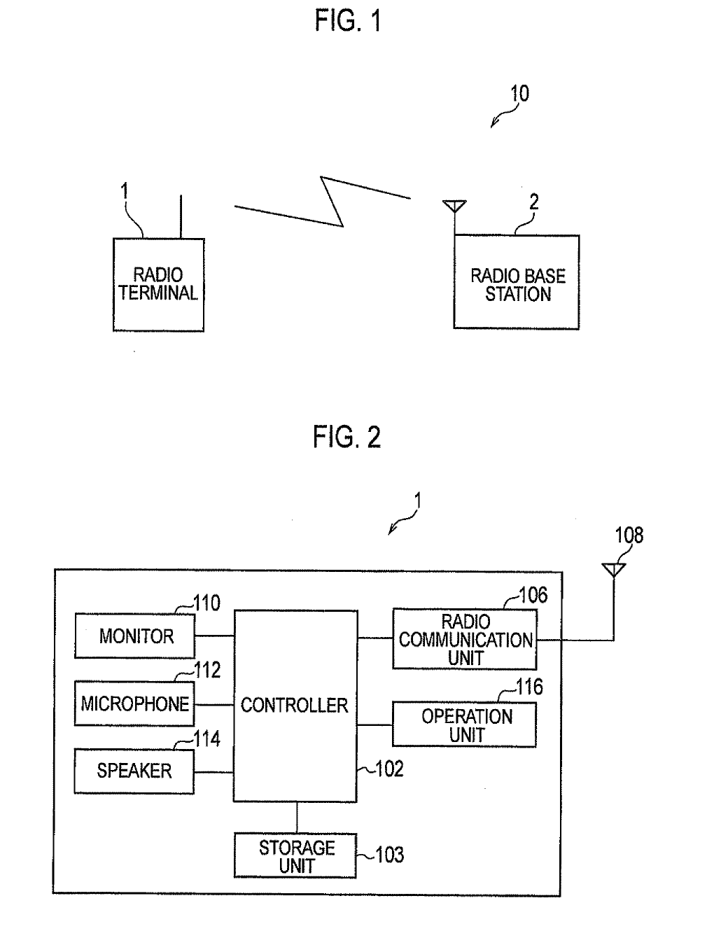

FIG. 1 is an overall schematic configuration view of a communication system 10 according to the first embodiment of the present invention.

The radio communication system 10 shown in FIG. 1 employs LTE (Long Term Evolution) that is a protocol developed by 3GPP (Third Generation Partnership Project). The radio communication system 10 includes a radio terminal 1 and a radio base station 2. In FIG. 1, the radio terminal 1 and the radio base station 2 transmit and receive signals with each other.

(1.2) Configuration of Radio Terminal

(1.2.1) Schematic Configuration View of Radio Terminal

FIG. 2 is a schematic configuration view of the radio terminal 1. As shown in FIG. 2, the radio terminal 1 includes a controller 102, a storage unit 103, a radio communication unit 106, an antenna 108, a monitor 110, a microphone 112, a speaker 114, and an operation unit 116.

The controller 102 is a CPU for example, and controls various functions of the radio terminal 1. The storage unit 103 is a memory for example, and stores therein various pieces of information used for control in the radio terminal 1 and the like.

The radio communication unit 106 transmits and receives a radio signal through the antenna 108.

The monitor 110 displays thereon an image and operation contents (such as inputted phone number and address) received through the controller 102. The microphone 112 collects sounds and outputs sound data based on the collected sounds to the controller 102. The speaker 114 outputs the sound based on the sound data acquired from the controller 102.

The operation unit 116, which is formed of ten-keys, function keys, and the like, is an interface through which operation contents of a user are inputted.

(1.2.2) Detailed Configuration of Radio Terminal

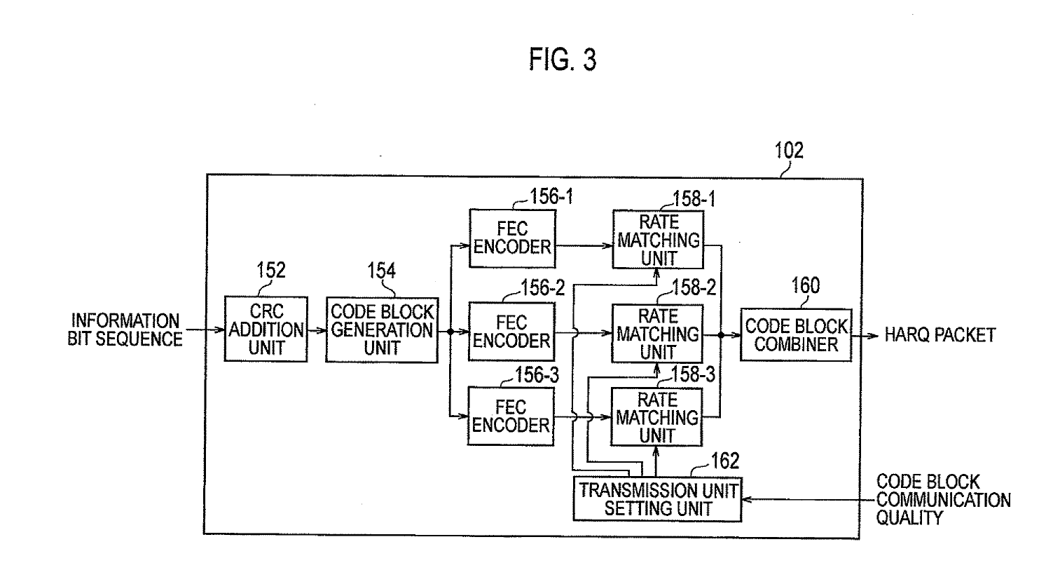

Next, detailed configuration of the radio terminal 1, more specifically, a functional block configuration of the controller 102 is described. FIG. 3 is a functional block configuration diagram of the controller 102 of the radio terminal 1.

As shown in FIG. 3, the controller 102 includes: a CRC addition unit 152; a code block generation unit 154; FEC encoders 156-1, 156-2, and 156-3; rate matching units 158-1, 158-2, and 158-3; a code block combiner 160; and a transmission unit setting unit 162.

The CRC addition unit 152 receives an information bit sequence, and then adds the CRC bit sequence to the information bit sequence to generate a bit sequence to be transmitted. Thereafter, the CRC addition unit 152 outputs the bit sequence to be transmitted to the code block generation unit 154.

The code block generation unit 154 receives the bit sequence to be transmitted. Then, the code block generation unit 154 divides the bit sequence to be transmitted into blocks of a predetermined length (code blocks). In this embodiment, the code block generation unit 154 divides the bit sequence to be transmitted into three code blocks (code blocks #1 to #3) of a predetermined length.

Then, the code block generation unit 154 outputs the code block #1 to the FEC encoder 156-1. Additionally, the code block generation unit 154 outputs the code block #2 to the FEC encoder 156-2, and outputs the code block #3 to the FEC encoder 156-3.

The FEC encoder 156-1 receives and encodes the code block #1. Then, the FEC encoder 156-1 outputs the encoded code block #1 to the rate matching unit 158-1 on the subsequent stage. Similarly, the FEC encoder 156-2 receives and encodes the code block #2 and then, outputs the encoded code block #2 to the rate matching unit 158-2 on the subsequent stage. Again similarly, the FEC encoder 156-3 receives and encodes the code block #3 and then, outputs the encoded code block #3 to the rate matching unit 158-3 on the subsequent stage. The encoded code blocks #1 to #3 each includes identification information thereof.

The rate matching unit 158-1 receives an encoded code block #1. Next, the rate matching unit 158-1 adds redundant bits #1 to the encoded code block #1 to generate a to-be-transmitted packet #1, the redundant bits #1 being a CRC bit sequence and used for error detection. Then, the rate matching unit 158-1 extracts a packet from the to-be-transmitted packet #1 by a first transmission unit at a time and outputs the packet to the code block combiner 160, the first transmission unit being set by the transmission unit setting unit 162.

Similarly, the rate matching unit 158-2 receives the encoded code block #2 and adds redundant bits #2 to the encoded code block #2 to generate a to-be-transmitted packet #2, the redundant bits #2 being a CRC bit sequence and used for error detection. Then, the rate matching unit 158-2 extracts a packet from the to-be-transmitted packet #2 by a second transmission unit at a time and outputs the packet to the code block combiner 160, the second transmission unit being set by the transmission unit setting unit 162. Again similarly, the rate matching unit 158-3 receives the encoded code block #3 and adds redundant bits #3 to the encoded code block #3 to generate a to-be-transmitted packet #3, the redundant bits #3 being a CRC bit sequence and used for error detection. Then, the rate matching unit 158-3 extracts a packet from the to-be-transmitted packet #3 by a third transmission unit at a time and outputs the packet to the code block combiner 160, the third transmission unit being set by the transmission unit setting unit 162. Note that, the redundant bits include identification information of the encoded code block to which the redundant bits are added.

The transmission unit setting unit 162 sets the first to the third transmission units described above. More particularly, the transmission unit setting unit 162 sets the first to the third transmission units so that, in the initial transmission to the radio base station 1, the first to the third transmission units have the same length and the total length of the first to the third transmission units is equal to the packet length of the HARQ packet which is fixed.

Moreover, upon receiving communication qualities (described later) of the respective code blocks #1 to #3 from the radio base station 2 through the antenna 108 and the radio communication unit 106, the transmission unit setting unit 162 sets the first to the third transmission units so that, in the retransmission to the radio base station 2, degradation levels of the communication qualities of the code blocks #1 to #3 are reflected on the ratio of the first to the third transmission units, and the total length of the first to the third transmission units is equal to the packet length of the HARQ packet which is fixed.

The code block combiner 160 receives the packet of the first transmission unit extracted from the to-be-transmitted packet #1, the packet of the second transmission unit extracted from the to-be-transmitted packet #2, and the packet of the third transmission unit extracted from the to-be-transmitted packet #3. The code block combiner 160 combines the packets to generate the HARQ packet. Then, the code block combiner 160 outputs the generated HARQ packet to the radio communication unit 106. The HARQ packet is transmitted to the radio base station 2 through the radio communication unit 106 and the antenna 108.

(1.3) Configuration of Radio Base Station

(1.3.1) Schematic Configuration View of Radio Base Station

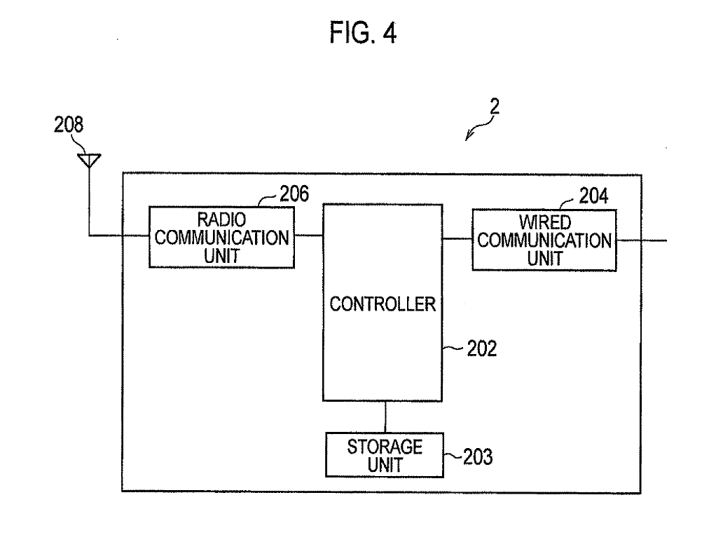

FIG. 4 is an overall schematic configuration view of the radio base station 2. As shown in FIG. 4, the radio base station 2 includes a controller 202, a storage unit 203, a wired communication unit 204, a radio communication unit 206, and an antenna 208.

The controller 202 is a CPU for example, and controls various functions of the radio base station 2. The storage unit 203 is a memory for example, and stores therein various pieces of information used for control in the radio base station 2 and the like.

The wired communication unit 204 communicates with a gateway server and the like in an unillustrated upper-level network. The radio communication unit 206 transmits and receives a radio signal through the antenna 208.

(1.3.2) Detailed Configuration of Radio Base Station

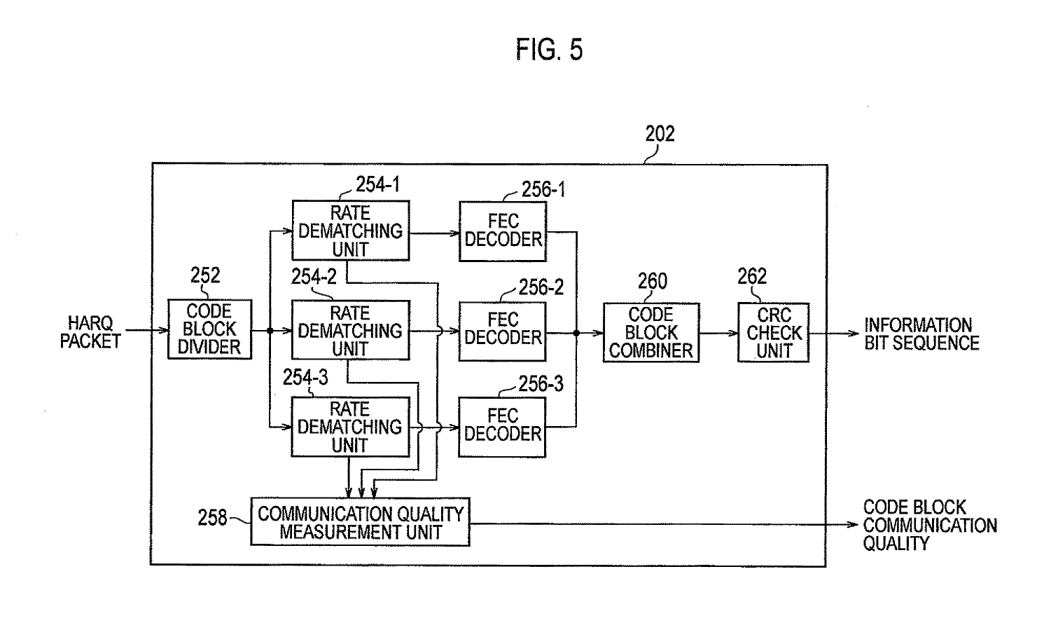

Next, detailed configuration of the radio base station 2, more specifically, a functional block configuration of the controller 202 is described. FIG. 5 is a functional block configuration diagram of the controller 202 of the radio base station 2.

As shown in FIG. 5, the controller 202 includes: a code block divider 252; a rate dematching units 254-1, 254-2, 254-3; FEC decoders 256-1, 256-2, and 256-3; a communication quality measurement unit 258; a code block combiner 260; and a CRC check unit 262.

The code block divider 252 receives the HARQ packet from the radio terminal 1 through the antenna 208 and the radio communication unit 206. Then, the code block divider 252 detects the identification information on the encoded code block, the identification information being included in the encoded code block in the HARQ packet, and the identification information on the encoded code block, to which the redundant bits are added, the identification information being included in the redundant bits in the HARQ packet.

Then, the code block divider 252 extracts the packet of the first transmission unit from the HARQ packet, the packet including the encoded code block #1 and the redundant bits #1 that include the identification information on the code block #1. The code block divider 252 then outputs the extracted packet to the rate dematching unit 254-1.

Similarly, the code block divider 252 extracts the packet of the second transmission unit from the HARQ packet, the packet including the encoded code block #2 and the redundant bits #2 that include the identification information on the code block #2. The code block divider 252 then outputs the extracted packet to the rate dematching unit 254-2. Again similarly, the code block divider 252 extracts the packet of the third transmission unit from the HARQ packet, the packet including the encoded code block #3 and the redundant bits #3 that include the identification information on the code block #3. The code block divider 252 then outputs the extracted packet to the rate dematching unit 254-3.

The rate dematching unit 254-1 receives the packet of the first transmission unit and extracts the code block #1 and the redundant bits #1 from the packet of the first transmission unit. Then, the rate dematching unit 254-1 outputs the code block #1 to the FEC decoder 256-1 and the communication quality measurement unit 258, and outputs the redundant bits #1 to the communication quality measurement unit 258.

Similarly, the rate dematching unit 254-2 receives the packet of the second transmission unit and extracts the code block #2 and the redundant bits #2 from the packet of the second transmission unit. Then, the rate dematching unit 254-2 outputs the code block #2 to the FEC decoder 256-2 and the communication quality measurement unit 258, and outputs the redundant bits 442 to the communication quality measurement unit 258. Again similarly, the rate dematching unit 254-3 receives the packet of the third transmission unit and extracts the code block #3 and the redundant bits #3 from the packet of the third transmission unit. Then, the rate dematching unit 254-3 outputs the code block #3 to the FEC decoder 256-3 and the communication quality measurement unit 258, and outputs the redundant bits #3 to the communication quality measurement unit 258.

The communication quality measurement unit 258 receives the code block #1 and the redundant bits #1 from the rate dematching unit 254-1. Similarly, the communication quality measurement unit 258 receives the code block #2 and the redundant bits #2 from the rate dematching unit 254-2, and receives the code block #3 and the redundant bits #3 from the rate dematching unit 254-3.

Then, the communication quality measurement unit 258 performs: error detection (CRC detection) on the code block #1 based on the redundant bits #1 which is a CRC bit sequence; the error detection on the code block #2 based on the redundant bits #2 which is a CRC bit sequence; and error detection on the code block #3 based on the redundant bits #3 which is a CRC bit sequence. Further, the communication quality measurement unit 258 outputs the results of the error detections on the code blocks #1 to #3 as the communication qualities of the code blocks #1 to #3 to the radio communication unit 206. The communication qualities of the code blocks #1 to #3 are transmitted to the radio terminal 1 through the radio communication unit 206 and the antenna 208.

In addition, the communication quality measurement unit 258 outputs ACK to the radio communication unit 206 if all the results of the error detections on the code blocks #1 to #3 indicate that there is no error. The communication quality measurement unit 258 outputs NACK to the radio communication unit 206 if any of the results of the error detections on the code blocks #1 to #3 indicate that there is an error. The ACK or the NACK is transmitted to the radio terminal 1 through the radio communication unit 206 and the antenna 208.

The FEC decoder 256-1 receives and decodes the code block #1. Further, the FEC decoder 256-1 outputs the decoded code block #1 to the code block combiner 260. Similarly, the FEC decoder 256-2 receives and decodes the code block #2 and the outputs the decoded code block #2 to the code block combiner 260. Again similarly, the FEC decoder 256-3 receives and decodes the code block #3 and outputs the decoded code block #3 to the code block combiner 260.

The code block combiner 260 receives the decoded code blocks #1 to #3. Then, the code block combiner 260 combines the decoded code blocks #1 to #3 to generate a bit sequence to be transmitted. Further, the code block combiner 260 outputs the generated bit sequence to be transmitted to the CRC check unit 262.

The CRC check unit 262 receives the bit sequence to be transmitted. Then, the CRC check unit 262 extracts the information bit sequence and the CRC bit sequence from the bit sequence to be transmitted and performs error detection on the information bit sequence based on the CRC bit sequence. Further, the CRC check unit 262 outputs the information bit sequence if no error is detected.

(2) Operation in Radio Communication System

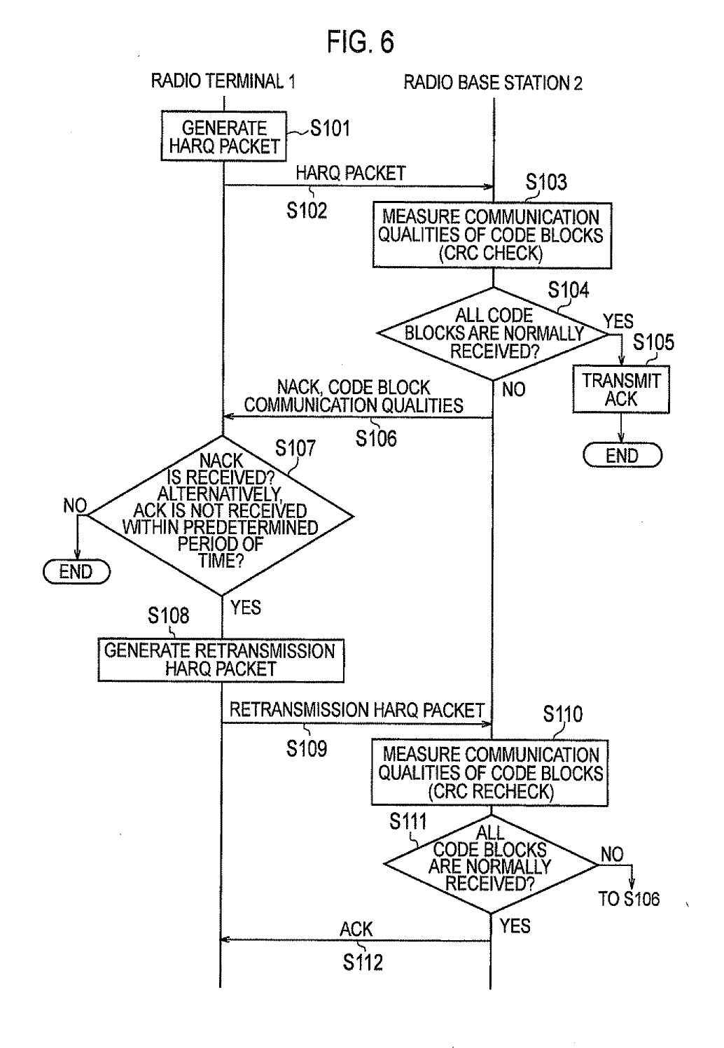

FIG. 6 is a sequence diagram showing operations of the radio terminal 1 and the radio base station 2 included in the radio communication system 10.

In Step S101, the radio terminal 1 generates the HARD packet.

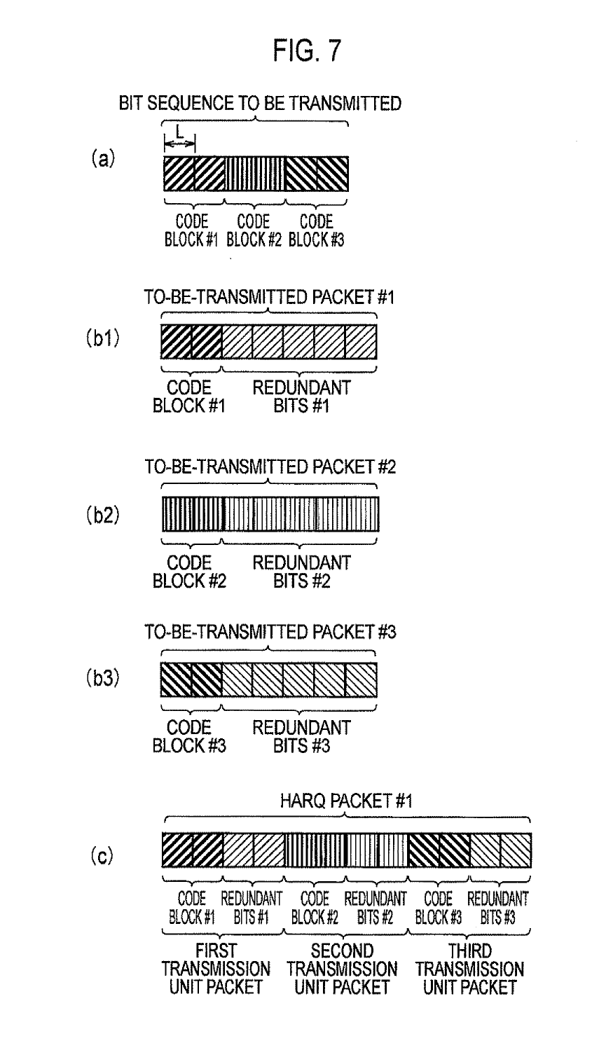

FIG. 7 is a diagram showing a HARQ packet generation step. In the following, a block of a minimum transmission unit is assumed to have a length L. In the first step shown in FIG. 7(a), the radio terminal 1 divides the bit sequence to be transmitted into the code blocks #1 to #3 each having the length 2L.

In the second step shown in FIGS. 7(b1) to (b3), the radio terminal 1 adds five redundant bits #1 to the code block #1, the redundant bits #1 each being the CRC bit sequence and having the length L. Thus, the to-be-transmitted packet #1 having the length 7L is generated. Similarly, the radio terminal 1 adds five redundant bits #2 to the code block #2, the redundant bits #2 each being the CRC bit sequence and having the length L. Thus, the to-be-transmitted packet #2 having the length 7L is generated. The radio terminal 1 adds five redundant bits #3 to the code block #3, the redundant bits #3 each being the CRC bit sequence and having the length L. Thus, the to-be-transmitted packet #3 having the length 7L is generated.

In the third step shown in FIG. 7(c), the transmission unit setting unit 162 sets each of the first to the third transmission units to be 4L, which is one-third of the packet length of the HARQ packet. Further, the radio terminal 1 extracts packets of the first to the third transmission units of 4L respectively from the head of the to-be-transmitted packets #1 to #3, and combines the packets to generate the HARQ packet #1 having the length 12L.

Again, referring back to FIG. 6, the radio terminal 1 transmits the HARQ packet in Step S102. The radio base station 2 receives the HARQ packet.

In Step S103, the communication quality measurement unit 258 in the radio base station 2 measures (performs CRC check for) the communication qualities of the code blocks included in the HARQ packet.

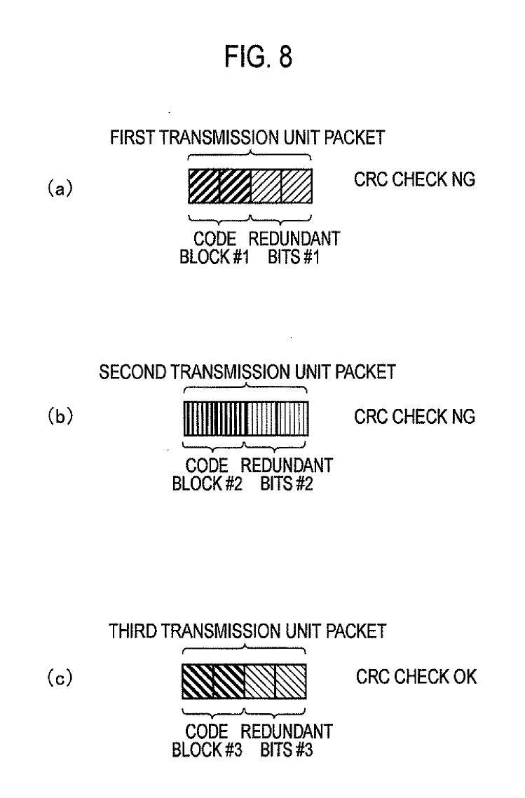

FIG. 8 is a diagram showing an example of the CRC check in Step S103. As shown in FIGS. 8(a) to (c), the communication quality measurement unit 258 extracts, from the HARQ packet shown in FIG. 7(c), the packet of the first transmission unit including the code block #1 and the redundant bits #1, the packet of the second transmission unit including the code block #2 and the redundant bits #2 and the packet of the third transmission unit including the code block #3 and the redundant bits #3.

Then, the communication quality measurement unit 258 performs CRC check on the code block #1 based on the redundant bits #1. Similarly, the communication quality measurement unit 258 performs CRC check on the code block #2 based on the redundant bits #2. Again similarly, the communication quality measurement unit 258 performs CRC check on the code block #3 based on the redundant bits #3. In FIG. 8, the results of the CRC checks on the code blocks #1 and #2 are NG, i.e., an error is detected in the code blocks #1 and #2, whereas the result of the CRC check on the code block #3 is OK, i.e., no error is detected in the code block #3.

Again, referring back to FIG. 6, in Step S104, the communication quality measurement unit 258 in the radio base station 2 determines whether or not an error is found in any of the code blocks, i.e., determines whether or not all the code blocks are normally received based on the CRC check in Step S103. If all the code blocks are normally received, the radio base station 2 transmits ACK to the radio terminal 1 in Step S105 and terminates the series of operations.

If there is a code block received abnormally (NO in Step S104), the radio base station 2 transmits NACK and the code block communication qualities to the radio terminal 1 in Step S106. For example, in the example of FIG. 7, the radio base station 2 transmits the code block communication qualities indicating that the result of the CRC checks on the code blocks #1 and #2 are NG and the result of the CRC check on the code block #3 is OK. The radio terminal 1 receives the code block communication qualities.

In Step S107, the radio terminal 1 determines whether the NACK is received from the radio base station or whether no ACK is received within a predetermined period of time. When receiving no NACK and receiving ACK within a predetermined period of time, the radio terminal 1 terminates the series of operations.

Conversely, when receiving NACK from the radio base station 2 or receiving no ACK from the radio base station 2 within a predetermined period of time, the radio terminal 1 generates a retransmission HARQ packet in Step S108.

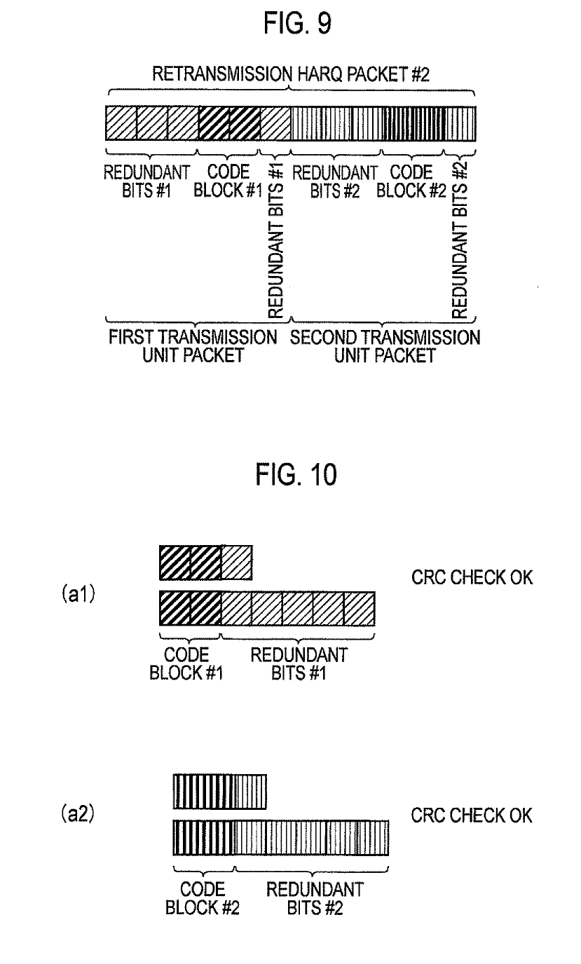

FIG. 9 is a diagram showing a structure of the retransmission HARQ packet. FIG. 9 shows an example where the results of the CRC checks on the code blocks #1 and #2 are NG and the result of the CRC check on the code block #3 is OK in radio base station 2.

In this case, retransmission is required for the code blocks #1 and #2 but not required for the code block #3. Thus, the transmission unit setting unit 162 in the radio terminal 1 sets each of the first and the second transmission units to be 6L which is the half of the packet length of the HARQ packet. Then the transmission unit setting unit 162 in the radio terminal 1 extracts from the to-be-transmitted packet #1, 6L of blocks starting from the block after the rear-most block in the blocks that have been transmitted the last time. Similarly, the transmission unit setting unit 162 in the radio terminal 1 extracts from the to-be-transmitted packet #2, 6L of blocks starting from the block after the rear-most block in the blocks that have been transmitted the last time. Further, the radio terminal 1 combines packets of the first and the second transmission units of 6L respectively extracted from the to-be-transmitted packets #1 and #2 to generate a retransmission HARQ packet #2 having the length 12L.

Again, referring back to FIG. 6, the radio terminal 1 transmits a retransmission HARQ packet in Step S109. The radio base station 2 receives the retransmission HARQ packet.

In Step S110, the communication quality measurement unit 258 in the radio base station 2 measures (performs CRC recheck for) the communication qualities of the code blocks included in the HARQ packet received in Step S102 and the retransmission HARQ packet received in Step S109.

FIG. 10 is a diagram showing an example of CRC recheck in Step S110. As shown in FIG. 10(a1), the communication quality measurement unit 258 in the radio base station 2 combines the code block #1 and the redundant bits #1 received in Step S102 with the code block #1 and the redundant bits #1 received in Step S109. Here, the code block 41 and the redundant bits #1 are each received twice. In this case, the communication quality measurement unit 258 in the radio base station 2 combines the Euclidean distances of the bit at the same position in the two code blocks #1 and the two redundant bits #1. The communication quality measurement unit 258 determines each bit of the code block #1 and the redundant bits #1 received twice based on the combined value of the Euclidean distances. The communication quality measurement unit 258 in the radio base station 2 performs the CRC check on the code block #1 based on the redundant bits #1.

Similarly, as shown in FIG. 10(a2), the communication quality measurement unit 258 in the radio base station 2 combines the code block #2 and the redundant bits #2 received in Step S102 with the code block #2 and the redundant bits #2 received in Step S109. Then, the communication quality measurement unit 258 in the radio base station 2 determines each bit of the code blocks #2 and the redundant bits #2 received twice. Thereafter, the communication quality measurement unit 258 in the radio base station 2 performs the CRC check on the code block #2 based on the redundant bits #2.

Again, referring back to FIG. 6, in Step S111, the radio base station 2 determines whether or not an error is found in any of the code blocks, i.e., determines whether or not all the code blocks are normally received based on the CRC recheck in Step S110. If all the code blocks are normally received, the radio base station 2 transmits ACK to the radio terminal 1 and the radio terminal 1 receives the ACK in Step S112. Thus, the series of operations are completed.

If there is a code block received abnormally (NO in Step S111), the radio base station 2 repeatedly transmits NACK and the code block communication qualities to the radio terminal 1 in Step S106 again.

### (3) Advantageous Effect

In the radio communication system 10 according to the first embodiment of the present invention, the radio terminal 1 on the transmitter side generates multiple to-be-transmitted packets each including a code block and redundant bits for error detection. Moreover, the radio terminal 1 generates the HARQ packet by combining the packets of the predetermined transmission units of the respective to-be-transmitted packets and transmits the HARQ packet.

The radio base station 2 on the receiver side extracts a packet of a predetermined transmission unit from the to-be-transmitted packet included in the received HARQ packet and performs the CRC check on the code block included in the to-be-transmitted packet based on the redundant bits included in the to-be-transmitted packet. The radio base station 2 transmits the result of the CRC check as the communication quality of the code block included in the to-be-transmitted packet.

Moreover, the radio terminal 1 sets the retransmission unit for each of the code blocks based on the result of the CRC check indicating the communication quality of each of the received code blocks. At this point, the radio terminal 1 so sets the transmission units for the to-be-transmitted packets each including the code block where the result of the CRC check is NG that the transmission units are the same and the total length of the transmission units is equal to the packet length of the HARQ packet which is fixed. Then, the radio terminal 1 combines the packets of the transmission units extracted from the to-be-transmitted packets to generate the HARQ packet and transmits the HARQ packet. On the other hand, the radio terminal 1 sets zero as the transmission unit of the to-be-transmitted packet including the code block where the result of the CRC check is OK. In other words, the radio terminal 1 retransmits no to-be-transmitted packet including the code block where the result of CRC check is OK. Accordingly, the retransmission unit varies among the code blocks depending on the communication qualities of the code blocks, whereby efficient retransmission control can be achieved.

### (4) Other Embodiment

As described above, the details of the present invention have been disclosed by using the embodiment of the present invention. However, it should not be understood that the description and drawings which constitute part of this disclosure limit the present invention. From this disclosure, various alternative embodiments, examples, and operation techniques will be easily found by those skilled in the art.

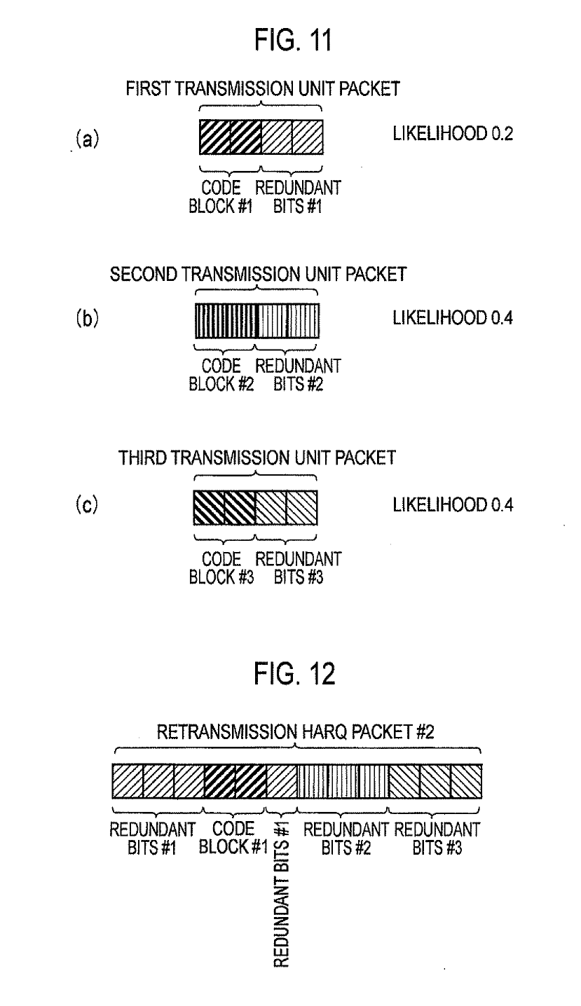

In the first embodiment described above, the communication quality measurement unit 258 in the radio base station 2 performs CRC check on the code blocks #1 to #3 respectively based on the redundant bits #1 to #3, the redundant bits #1 to #3 being CRC bit sequences. However, if the redundant bits #1 to #3 are not the CRC bit sequences, the likelihoods of the code blocks #1 to #3 based on the redundant bits #1 to #3 may be detected and used as the communication qualities of the code blocks #1 to #3. FIG. 11 is a diagram showing an example of likelihood detection for the code blocks #1 to #3.

Furthermore, the transmission unit setting unit 162 in the radio terminal 1 may so set the first to the third transmission units based on the likelihoods among the code blocks #1 to #3 that the ratio of the first to the third transmission units is based on the inverse of the likelihoods of the code blocks #1 to #3, and the total length of the first to the third transmission units is equal to the packet length of the HARQ packet which is fixed.

For example, as shown in FIG. 11, if the likelihood of the code block #1 is 0.2 and the likelihoods of the code blocks #2 and #3 are 0.4, the ratio of the first to the third transmission units is 1/0.2:1/0.4:1/0.4, i.e., 2:1:1. If the length of the HARQ packet is 12L, the first transmission unit is 6L, and the second and the third transmission units are 3L.

Then, the radio terminal 1 generates the retransmission HARQ packet by combining the packet of the first transmission unit of the tobe-transmitted packet #1, the packet of the second transmission unit of the to-be-transmitted packet #2, and the packet of the third transmission unit of the to-be-transmitted packet #3, and transmits the generated retransmission HARQ packet to the radio base station 2. FIG. 12 is a diagram showing a configuration of the retransmission HARQ packet with first transmission unit being 6L, and the second and the third transmission units each being 3L.

After receiving the retransmission HARQ packet, the communication quality measurement unit 258 in the radio base station 2 measures the communication quality (likelihood redetection) for each of the code blocks included in the pre-received HARQ packet and the newly received retransmission HARQ packet.

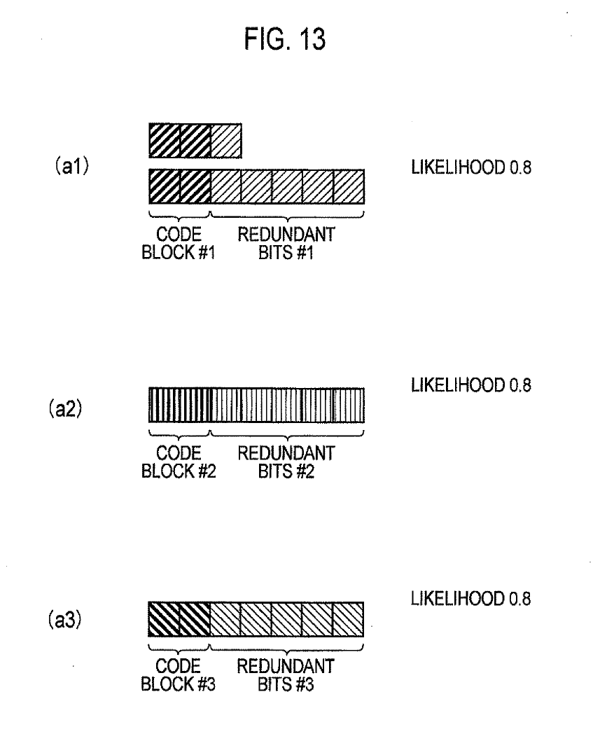

FIG. 13 is a diagram showing an example of likelihood redetection. As shown in FIG. 13(a1), the communication quality measurement unit 258 in the radio base station 2 combines the pre-received code block #1 and the redundant bits #1 with the newly received code block #1 and the redundant bits #1. Here, the code block #1 and the redundant bits #1 are both received twice. In this case, the communication quality measurement unit 258 in the radio base station 2 combines the Euclidean distances of the bit at the same position in the two code blocks #1 and the two redundant bits #1. The communication quality measurement unit 258 determines each bit of the code block #1 and the redundant bits #1 received twice based on the combined value of the Euclidean distances. Furthermore, the communication quality measurement unit 258 in the radio base station 2 detects the likelihood of the code block #1 based on the redundant bits #1.

In addition, as shown in FIG. 13(a2), the communication quality measurement unit 258 in the radio base station 2 combines the pre-received code block #2 and the redundant bits #2 with the newly received redundant bits #2 to detect the likelihood of the code block #2 based on the redundant bits #2. Similarly, as shown in FIG. 13(a3), the communication quality measurement unit 258 in the radio base station 2 combines the pre-received code block #3 and the redundant bits #3 with the newly received redundant bits #3 to detect the likelihood of the code block #3 based on the redundant bits #3.

Then, the radio base station 2 determines whether or not an error is present in any of the code blocks, i.e., whether or not all the code blocks are received normally, based on the result of the likelihood redetection. If, for example, the likelihood of 0.8 or more is regarded as the normal reception, the code blocks #1 to #3 are determined to be normally received in the example of FIG. 13.

If all the code blocks are normally received, the radio base station 2 transmits ACK and the radio terminal 1 receives the ACK. If there is any code block received abnormally, the radio base station 2 transmits NACK and the communication qualities of the code blocks to the radio terminal 1.

### Second Embodiment

Now, a second embodiment of the present invention is described with reference to the drawings. Specifically, description is given of (1) Configuration of Communication System, (2) Operation in Communication System, (3) Advantageous Effect, and (4) Other Embodiment. In the description of the drawings for the embodiment below, the same or similar components are given the same or similar reference numerals.

### (1) Configuration of Communication System First of all, the configuration of a communication system according to the first embodiment of the present invention is described in the order of (1.1) Overall Schematic Configuration of Communication System, and (1.2) Configuration of Communication Apparatus.

(1.1) Overall Schematic Configuration of Communication System

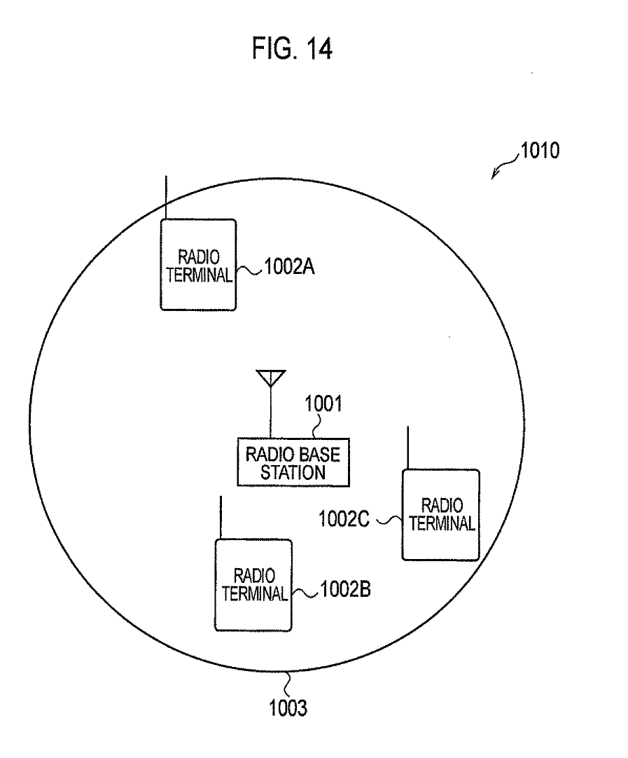

FIG. 14 is an overall schematic configuration view of a communication system according to the embodiment of the present invention. The radio communication system 10 shown in FIG. 14 employs LTE that is a protocol developed by 3GPP. The radio communication system 1010 shown in FIG. 14 includes a radio base station 1001, a radio terminal 1002A, a radio terminal 1002B, and a radio terminal 1002C. In FIG. 14, the radio terminals 1002A to 1002C are located in a cell 1003 provided by the radio base station 1001.

The radio base station 1001 simultaneously transmits the HARQ packets that include multiple code blocks obtained by dividing a bit sequence of the same information to the radio terminals 1002A to 1002C through multicast communication.

(1.2) Configuration of Radio Base Station

(1.2.1) Schematic Configuration View of Radio Base Station

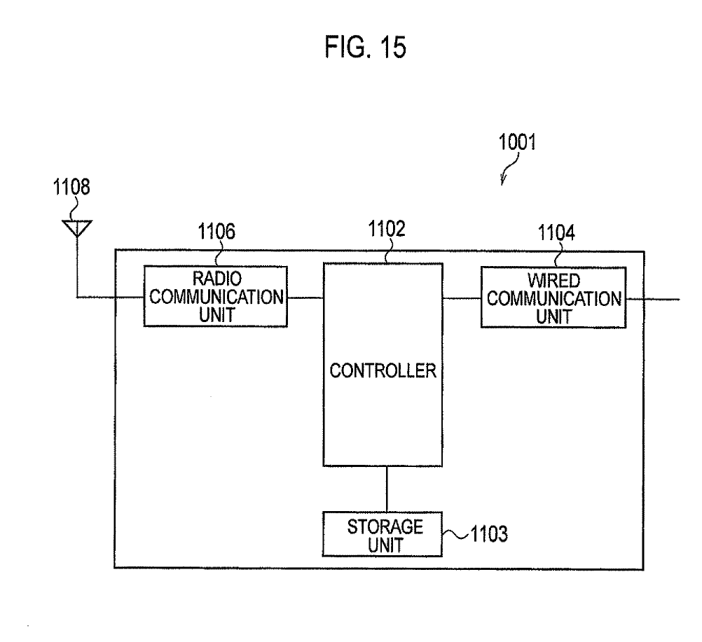

FIG. 15 is a schematic configuration view of the radio base station 1001. As shown in FIG. 15, the radio base station 1001 includes a controller 1102, a storage unit 1103, a wired communication unit 1104, a radio communication unit 1106, and an antenna 1108.

The controller 1102 is a CPU for example, and controls various functions of the radio base station 1001. The storage unit 1103 is a memory for example, and stores therein various pieces of information used for control in the radio base station 1001 and the like.

The wired communication unit 1104 communicates with a gateway server and the like in an unillustrated upper-level network. The radio communication unit 1106 transmits and receives a radio signal through the antenna 1108.

(1.2.2) Detailed Configuration of Radio Base Station

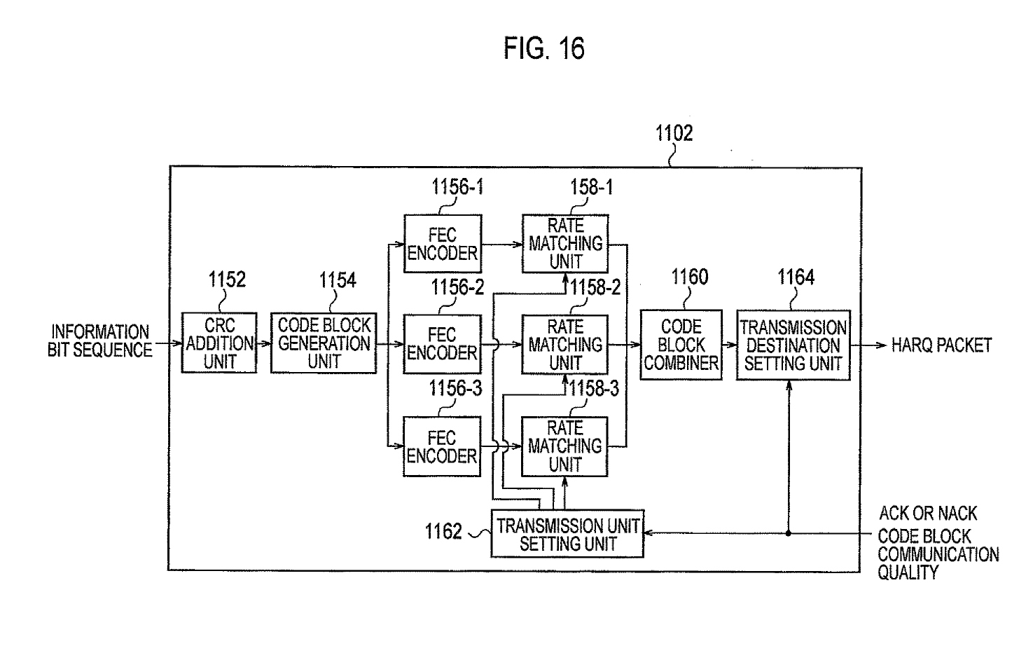

Next, detailed configuration of the radio base station 1001, more specifically, a functional block configuration of the controller 1102 is described. FIG. 16 is a functional block configuration diagram of the controller 1102 of the radio base station 1001.

As shown in FIG. 16, the controller 1102 includes: a CRC addition unit 1152; a code block generation unit 1154; FEC encoders 1156-1, 1156-2, and 1156-3; rate matching units 1158-1, 1158-2, and 1158-3; a code block combiner 1160; a transmission unit setting unit 1162; and a transmission destination setting unit 1164.

The CRC addition unit 1152 receives an information bit sequence, and then adds the CRC bit sequence to the information bit sequence to generate a bit sequence to be transmitted. Thereafter, the CRC addition unit 1152 outputs the bit sequence to be transmitted to the code block generation unit 1154.

The code block generation unit 1154 receives the bit sequence to be transmitted. Then, the code block generation unit 1154 divides the bit sequence to be transmitted into blocks of a predetermined length (code blocks). In this embodiment, the code block generation unit 1154 divides the bit sequence to be transmitted into three code blocks (code blocks #1 to #3) of a predetermined length.

Then, the code block generation unit 1154 outputs the code block #1 to the FEC encoder 1156-1. Additionally, the code block generation unit 1154 outputs the code block #2 to the FEC encoder 1156-2, and outputs the code block #3 to the FEC encoder 1156-3.

The FEC encoder 1156-1 receives and encodes the code block #1. Then, the FEC encoder 1156-1 outputs the encoded code block #1 to the rate matching unit 1158-1 on the subsequent stage. Similarly, the FEC encoder 1156-2 receives and encodes the code block #2 and then, outputs the encoded code block #2 to the rate matching unit 1158-2 on the subsequent stage. Again similarly, the FEC encoder 1156-3 receives and encodes the code block #3 and then, outputs the encoded code block #3 to the rate matching unit 1158-3 on the subsequent stage. The encoded code blocks #1 to #3 each includes identification information thereof.

The rate matching unit 1158-1 receives the encoded code block #1. Next, the rate matching unit 1158-1 adds redundant bits #1 to the encoded code block #1 to generate a to-be-transmitted packet #1, the redundant bits #1 being a CRC bit sequence and used for error detection. Then, the rate matching unit 1158-1 extracts a packet from the to-be-transmitted packet #1 by a first transmission unit at a time and outputs the packet to the code block combiner 1160, the first transmission unit being set by the transmission unit setting unit 1162.

Similarly, the rate matching unit 1158-2 receives a encoded code block #2, and adds redundant bits #2 to the encoded code block #2 to generate a to-be-transmitted packet #2, the redundant bits #2 being a CRC bit sequence and used for error detection. Then, the rate matching unit 1158-2 extracts a packet from the to-be-transmitted packet #2 by a second transmission unit at a time and outputs the packet to the code block combiner 1160, the second transmission unit being set by the transmission unit setting unit 1162. Again similarly, the rate matching unit 1158-3 receives a encoded code block #3, and adds redundant bits #3 to the encoded code block #3 to generate a to-be-transmitted packet #3, the redundant bits #3 being a CRC bit sequence and used for error detection. Then, the rate matching unit 1158-3 extracts a packet from the to-be-transmitted packet #3 by a third transmission unit at a time and outputs the packet to the code block combiner 1160, the third transmission unit being set by the transmission unit setting unit 1162. Note that, the redundant bits include identification information of the encoded code block to which the redundant bits are added.

The transmission unit setting unit 1162 sets the first to the third transmission units described above. More particularly, the transmission unit setting unit 1162 sets the first to the third transmission units so that, in the initial transmission to the radio terminals 1002A to 1002C, the first to the third transmission units have the same length and the total length of the first to the third transmission units is equal to the packet length of the HARQ packet which is fixed.

Moreover, upon receiving communication qualities (described later) of the respective code blocks #1 to #3 from the radio terminals 1002A to 1002C through the antenna 1108 and the radio communication unit 1106, the transmission unit setting unit 1162 sets the first to the third transmission units so that, in the retransmission to the radio terminals 1002A to 1002C, degradation levels of the communication qualities of the code blocks #1 to #3 are reflected on the ratio of the first to the third transmission units, and the total length of the first to the third transmission units is equal to the packet length of the HARQ packet which is fixed.

The code block combiner 1160 receives the packet of the first transmission unit extracted from the to-be-transmitted packet #1, the packet of the second transmission unit extracted from the to-be-transmitted packet #2, and the packet of the third transmission unit extracted from the to-be-transmitted packet #3. The code block combiner 1160 combines the packets to generate the HARQ packet. Then, the code block combiner 1160 outputs the generated HARQ packet to the transmission destination setting unit 1164.

For the initial transmission to the radio terminals 1002A to 1002C, the transmission destination setting unit 1164 sets the radio terminals 1002A to 1002C located in the cell 1003 as the destinations of the HARQ packet. Then, the transmission destination setting unit 1164 outputs the HARQ packet to the radio communication unit 1106 after adding the information on the set destinations to the HARQ packet. The HARQ packet is transmitted to the radio terminals 1002A to 1002C set as the destinations through the radio communication unit 1106 and the antenna 1108.

For the retransmission to the radio terminals 1002A to 1002C, the destination setting unit 1164 receiving ACK or NACK through the antenna 1108 and the radio communication unit 1106 excludes the radio terminal that has transmitted the ACK from the destination and sets only the radio terminal that has transmitted the NACK as the destination, the ACK indicating that the HARQ packet is normally received in the radio terminals 1002A to 1002C, the NACK indicating that the HARQ packet is not normally received in the radio terminals 1002A to 1002C. Moreover, as described above, the destination setting unit 1164 adds the information on the set destination to the HARQ packet and outputs the HARQ packet to the radio communication unit 1106. The HARQ packet is transmitted to the radio terminal set as the destination through the radio communication unit 1106 and the antenna 1108.

(1.3) Configuration of Radio Terminal

(1.3.1) Schematic Configuration of Radio Terminal

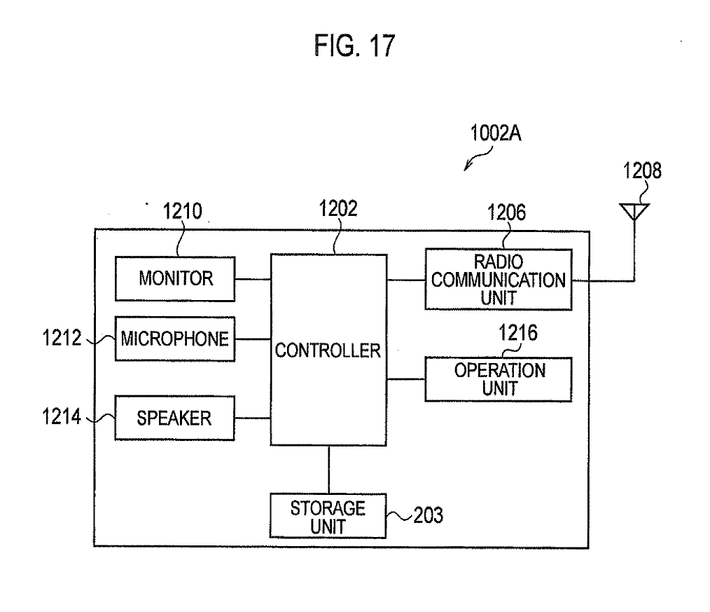

FIG. 17 is a schematic configuration view of the radio terminal 1002A. As shown in FIG. 17, the radio terminal 1002A includes a controller 1202, a storage unit 1203, a radio communication unit 1206, an antenna 1208, a monitor 1210, a microphone 1212, a speaker 1214, and an operation unit 1216. Note that, the radio terminals 1002E and 1002C have the same configuration as the radio terminal 1002A.

The controller 1202 is a CPU for example, and controls various functions of the radio terminal 1002A. The storage unit 1203 is a memory for example, and stores therein various pieces of information used for control in the radio terminal 1002A and the like.

The radio communication unit 1206 transmits and receives a radio signal through the antenna 1208.

The monitor 1210 displays thereon an image and operation contents (such as inputted phone number and address) received through the controller 1202. The microphone 1212 collects sounds and outputs sound data based on the collected sounds to the controller 1202. The speaker 1214 outputs the sound based on the sound data acquired from the controller 1202.

The operation unit 1216, which is formed of ten-keys, function keys, and the like, is an interface through which operation contents of a user are inputted.

(1.3.2) Detailed Configuration of Radio Terminal

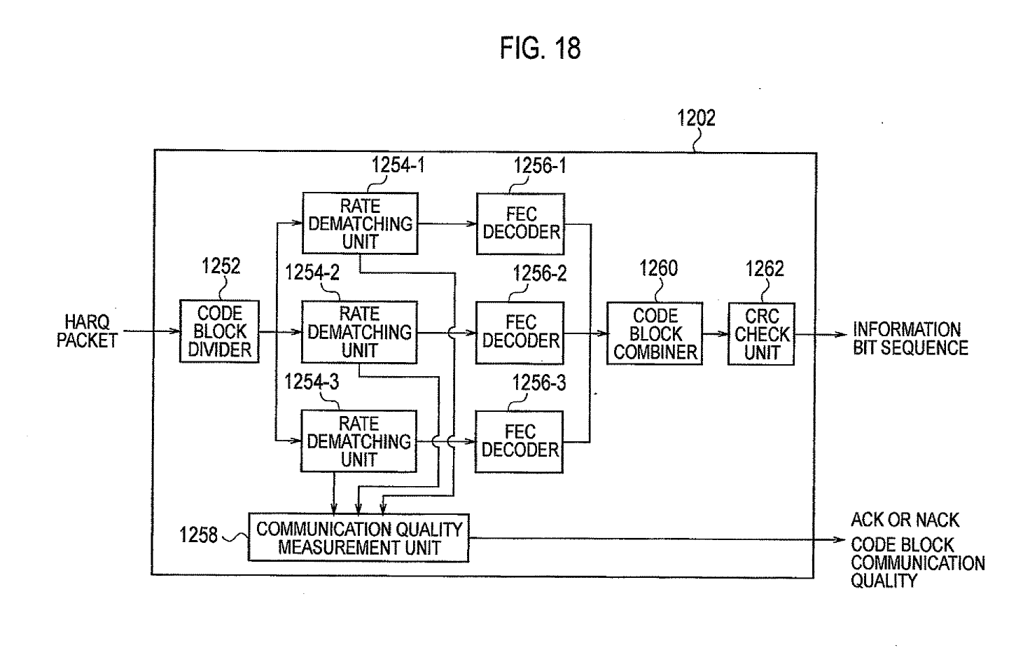

Next, detailed configuration of the radio terminal 1002A, more specifically, a functional block configuration of the controller 1202 is described. FIG. 18 is a functional block configuration diagram of the controller 1202 of the radio to terminal 1002A. Note that, the controller 1202 of the radio terminals 1002B and 1002C has the same configuration as the controller 1202 of the radio terminal 1002A.

As shown in FIG. 18, the controller 1202 includes: a code block divider 1252; a rate dematching units 1254-1, 1254-2, 1254-3; FEC decoders 1256-1, 1256-2, and 1256-3; a communication quality measurement unit 1258; a code block combiner 1260; and a CRC check unit 1262.

The code block divider 1252 receives the HARQ packet from the radio base station 1001 through the antenna 1208 and the radio communication unit 1206. Then, the code block divider 1252 detects the identification information on the encoded code block, the identification information being included in the encoded code block in the HARQ packet, and the identification information on the encoded code block to which the redundant bits are added, the identification information being included in the redundant bits in the HARQ packet.

Then, the code block divider 1252 extracts the packet of the first transmission unit from the HARQ packet, the packet including the encoded code block #1 and the redundant bits #1 that include the identification information on the code block #1. The code block divider 1252 then outputs the extracted packet to the rate dematching unit 1254-1.

Similarly, the code block divider 1252 extracts the packet of the second transmission unit from the HARQ packet, the packet including the encoded code block #2 and the redundant bits #2 that include the identification information on the code block #2. The code block divider 1252 then outputs the extracted packet to the rate dematching unit 1254-2. Again similarly, the code block divider 1252 extracts the packet of the third transmission unit from the HARQ packet, the packet including the encoded code block #3 and the redundant bits #3 that include the identification information on the code block #3. The code block divider 1252 then outputs the extracted packet to the rate dematching unit 1254-3.

The rate dematching unit 1254-1 receives the packet of the first transmission unit and extracts the code block #1 and the redundant bits #1 from the packet of the first transmission unit. Then, the rate dematching unit 1254-1 outputs the code block #1 to the FEC decoder 1256-1 and the communication quality measurement unit 1258, and outputs the redundant bits #1 to the communication quality measurement unit 1258.

Similarly, the rate dematching unit 1254-2 receives the packet of the second transmission unit and extracts the code block #2 and the redundant bits #2 from the packet of the second transmission unit. Then, the rate dematching unit 1254-2 outputs the code block #2 to the FEC decoder 1256-2 and the communication quality measurement unit 1258, and outputs the redundant bits #2 to the communication quality measurement unit 1258. Again similarly, the rate dematching unit 1254-3 receives the packet of the third transmission unit and extracts the code block #3 and the redundant bits #3 from the packet of the third transmission unit. Then, the rate dematching unit 1254-3 outputs the code block #3 to the FEC decoder 1256-3 and the communication quality measurement unit 1258, and outputs the redundant bits #3 to the communication quality measurement unit 1258.

The communication quality measurement unit 1258 receives the code block #1 and the redundant bits #1 from the rate dematching unit 1254-1. Similarly, the communication quality measurement unit 1258 receives the code block #2 and the redundant bits #2 from the rate dematching unit 1254-2, and receives the code block #3 and the redundant bits #3 from the rate dematching unit 1254-3.

Then, the communication quality measurement unit 1258 performs: error detection (CRC detection) on the code block #1 based on the redundant bits #1 which is a CRC bit sequence; the error detection on the code block #2 based on the redundant bits #2 which is a CRC bit sequence; and error detection on the code block #3 based on the redundant bits #3 which is a CRC bit sequence. Further, the communication quality measurement unit 1258 outputs the results of the error detections on the code blocks #1 to #3 as the communication qualities of the code blocks #1 to #3 to the radio communication unit 1206. The communication qualities of the code blocks #1 to #3 are transmitted to the radio base station 1001 through the radio communication unit 1206 and the antenna 1208.

In addition, the communication quality measurement unit 1258 outputs ACK representing normal reception to the radio communication unit 1206 if all the results of the error detections on the code blocks #1 to #3 indicate that there is no error. The communication quality measurement unit 1258 outputs NACK representing abnormal reception to the radio communication unit 1206 if any of the results of the error detections on the code blocks #1 to #3 indicate that there is an error. The ACK or the NACK is transmitted to the radio base station 1001 through the radio communication unit 1206 and the antenna 1208.

The FEC decoder 1256-1 receives and decodes the code block #1. Further, the FEC decoder 1256-1 outputs the decoded code block 41 to the code block combiner 1260. Similarly, the FEC decoder 1256-2 receives and decodes the code block #2 and the outputs the decoded code block 42 to the code block combiner 1260. Again similarly, the FEC decoder 1256-3 receives and decodes the code block #3 and outputs the decoded code block #3 to the code block combiner 1260.

The code block combiner 1260 receives the decoded code blocks #1 to #3. Then, the code block combiner 1260 combines the decoded code blocks #1 to #3 to generate a bit sequence to be transmitted. Further, the code block combiner 1260 outputs the generated bit sequence to be transmitted to the CRC check unit 1262.

The CRC check unit 1262 receives the bit sequence to be transmitted. Then, the CRC check unit 1262 extracts the information bit sequence and the CRC bit sequence from the bit sequence to be transmitted and performs error detection on the information bit sequence based on the CRC bit sequence. Further, the CRC check unit 1262 outputs the information bit sequence if no error is detected.

### (2) Operation in Radio Communication System

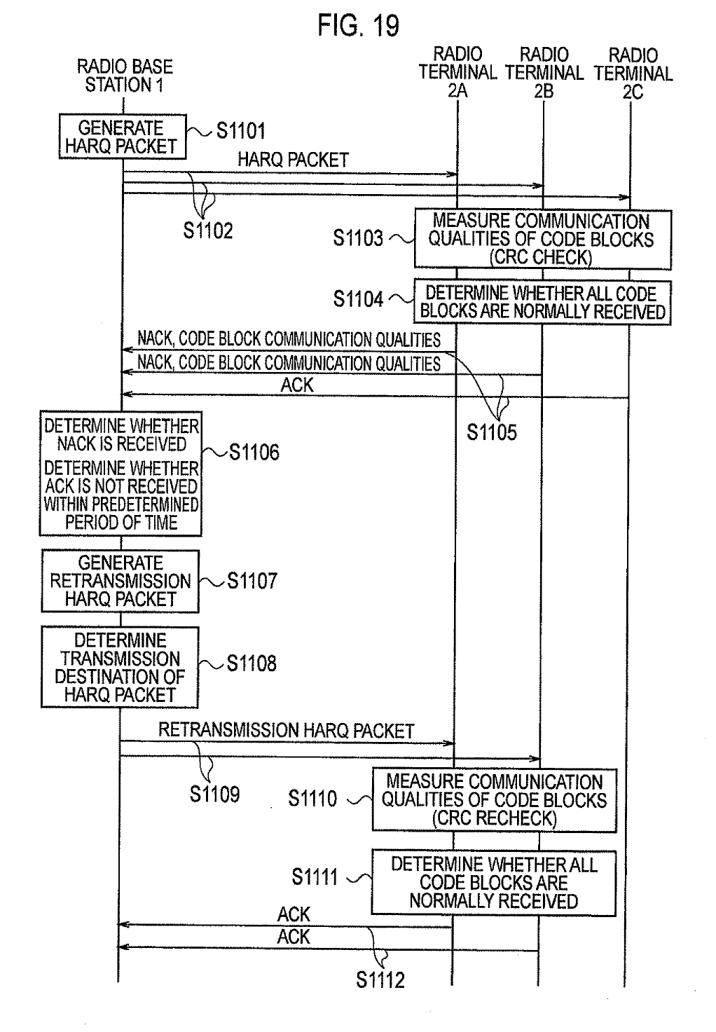

FIG. 19 is a sequence diagram showing operations of the radio base station 1001 and the radio terminals 1002A to 1002C included in the radio communication system 1010.

In Step S1101, the radio base station 1001 generates the HARQ packet.

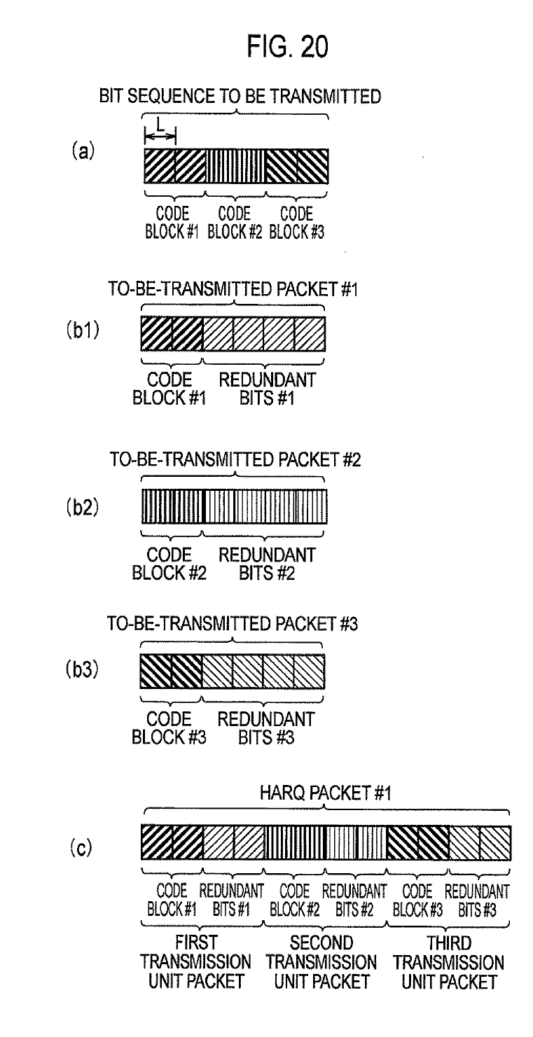

FIG. 20 is a diagram showing a HARQ packet generation step. In the following, a block of a minimum transmission unit is assumed to have a length L. In the first step shown in FIG. 20(a), the radio base station 1001 divides the bit sequence to be transmitted into the code blocks #1 to #3 each having the length 2L.

In the second step shown in FIGS. 20(b1) to (b3), the radio base station 1001 adds four redundant bits #1 to the code block #1, the redundant bits #1 each being the CRC bit sequence and having the length L. Thus, the to-be-transmitted packet #1 having the length 6L is generated. Similarly, the radio base station 1001 adds four redundant bits #2 to the code block #2, the redundant bits #2 each being the CRC bit sequence and having the length L. Thus, the to-be-transmitted packet #2 having the length 6L is generated. The radio base station 1001 adds four redundant bits #3 to the code block #3, the redundant bits #3 each being the CRC bit sequence and having the length L. Thus, the to-be-transmitted packet #3 having the length 6L is generated.

In the third step shown in FIG. 20(c), the transmission unit setting unit 1162 sets each of the first to the third transmission units to be 4L, which is one-third of the packet length of the HARQ packet. Further, the radio base station 1001 extracts packets of the first to the third transmission units of 4L respectively from the head of the to-be-transmitted packets #1 to #3, and combines the packets to generate the HARQ packet #1 having the length 12L.

Again, referring back to FIG. 19, in Step S1102, the radio base station 1001 transmits the same HARQ packets to the radio terminals 1002A to 1002C set as the destinations through multicast communication. The radio terminals 1002A to 1002C receive the HARQ packets.

In Step S1103, the communication quality measurement unit 1258 in the radio terminals 1002A to 1002C measures (performs CRC check for) the communication qualities of the code blocks included in the HARQ packet.

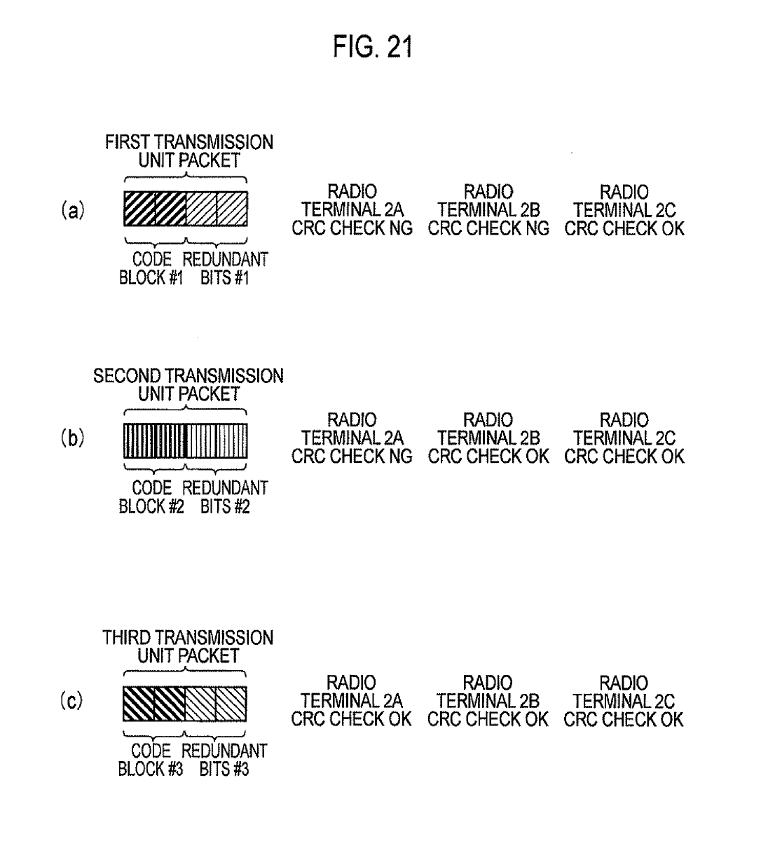

FIG. 21 is a diagram showing an example of the CRC check in Step S1103. As shown in FIGS. 21(a) to (c), the communication quality measurement unit 1258 extracts, from the HARQ packet shown in FIG. 20(c), the packet of the first transmission unit including the code block #1 and the redundant bits #1, the packet of the second transmission unit including the code block #2 and the redundant bits #2, and the packet of the third transmission unit including the code block #3 and the redundant bits #3.

Then, the communication quality measurement unit 1258 it) performs CRC check on the code block #1 based on the redundant bits #1. Similarly, the communication quality measurement unit 1258 performs CRC check on the code block #2 based on the redundant bits #2. Again similarly, the communication quality measurement unit 1258 performs CRC check on the code block #3 based on the redundant bits #3.

In FIG. 21, the result of the CRC check on the code block #1 is NG in the radio terminals 1002A and 1002B, i.e., an error is detected in the code blocks #1 and #2, whereas the result of the CRC check is OK in the radio terminal 1002C, i.e., no error is detected in the code block #1. The result of the CRC check on the code block #2 is NG in the radio terminal 1002A, whereas the result of the CRC check is OK in the radio terminals 1002E and 1002C. In addition, the result of the CRC check on the code bock #3 is OK in any of the radio terminals 1002A to 1002C.

Again, referring back to FIG. 19, in Step S1104, the communication quality measurement unit 1258 in the radio terminals 1002A to 1002C determines whether or not an error is found in any of the code blocks, i.e., determines whether or not all the code blocks are normally received based on the CRC check in Step S103.

Here, as shown in FIG. 21, the results of the CRC checks on the code blocks #1 and #2 are NG and the result of the CRC check on the code block #3 is OK in the radio terminal 1002A, and thus the code blocks #1 and #2 are not normally received by the radio terminal 1002A. Thus in Step S1105, the radio terminal 1002A transmits NACK as well as the result of the CRC check NG as the communication quality of the code block #1, the result of the CRC check NG as the communication quality of the code block #2, and the result of the CRC check OK as the communication quality of the code block #3 to the radio base station 1001.

Moreover, the result of the CRC check on the code block #1 is NG and the results of the CRC checks on the code blocks #2 and #3 are OK in the radio terminal 1002B, and thus the code block #1 is not normally received by the radio terminal 1002B. Thus in Step S1105, the radio terminal 1002B transmits NACK as well as the result of the CRC check NG as the communication quality of the code block #1, the result of the CRC check OK as the communication quality of the code block #2, and the result of the CRC check OK as the communication quality of the code block #3 to the radio base station 1001.

Furthermore, the results of the CRC checks on the code blocks #1 to #3 are OK and all the code blocks #1 to #3 are normally received by the radio terminal 1002C. Thus in Step S1105, the radio terminal 1002C transmits ACK to the radio base station 1001 and terminates the series of operations.

On the other hand, in Step S1105, the radio base station 1001 receives: NACK as well as the results of the CRC checks on the code blocks #1 to #3 from the radio base terminal 1002A; NACK as well as the results of the CRC checks on the code blocks #1 to #3 from the radio base terminal 1002B; and ACK from the radio terminal 1002C.

In Step S1106 the radio base station 1001 determines whether NACK is received from the radio terminals 1002A to 1002C, or whether no ACK is received from the radio terminals 1002A to 1002C within a predetermined period of time.

If no NACK is received from the radio terminals 1002A to 1002C and ACK is received from the radio terminals 1002A to 1002C within a predetermined period of time, the radio base station 1001 terminates the series of operations.

Here, the radio base station 1001 received NACK from the radio terminal 1002A and 1002B as well as ACK from the radio terminal 1002C. In this case, the radio base station 1001 generates the retransmission HARQ packet in Step S1107.

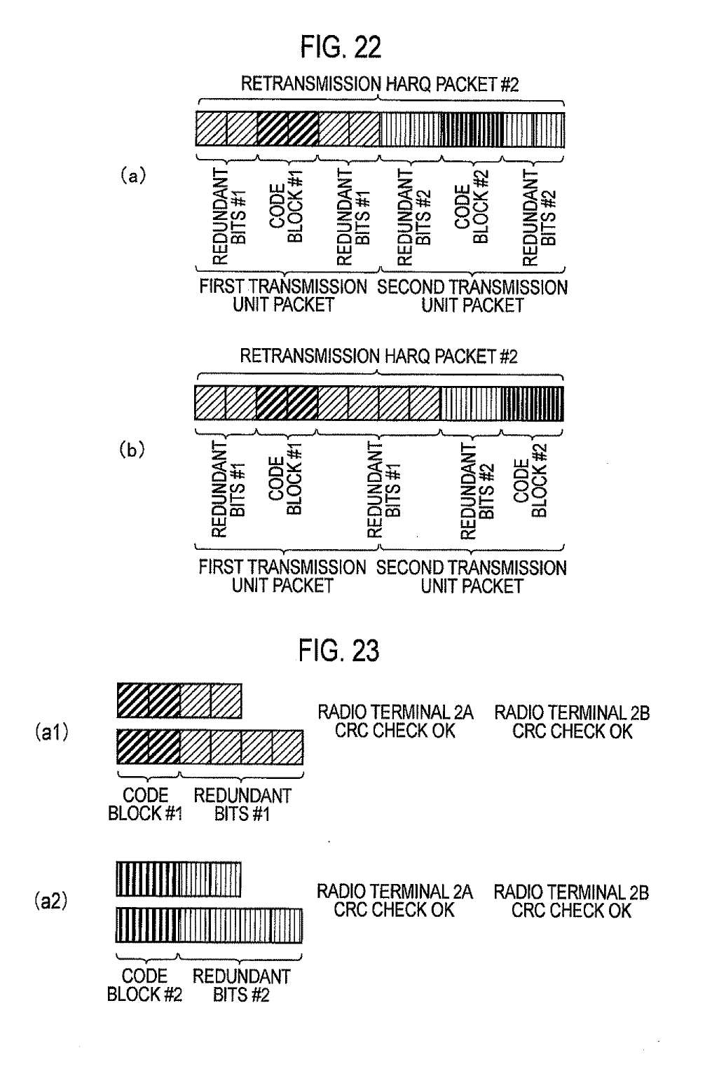

FIG. 22 is a diagram showing a structure of the retransmission HARQ packet. As in the case of FIG. 21, FIG. 22 shows an example where: the result of the CRC check on the code block #1 is NG in the radio terminals 1002A and 1002B but is OK in the radio terminal 1002C; the result of the CRC check on the code block #2 is NG in the radio terminal 1002A but is OK in the radio terminals 1002B and 1002C; and the result of the CRC check on the code block #3 is OK in the radio terminals 1002A and 1002C.

In this case, retransmission is required for the code blocks #1 and #2 but not required for the code block #3.

The transmission unit setting unit 1162 in the radio base station 1001 works out the representative level of the communication qualities of the code blocks #1 and #2. Specifically, the transmission unit setting unit 1162 sets NG as the representative level if any one of the results of the CRC checks on the radio terminals 1002A and 1002B is NG. In FIG. 21, the transmission unit setting unit 1162 sets NG as the representative level of the code block #1 because the results of CRC checks on the code block #1 in the radio terminals 1002A AND 1002B are both NG. In FIG. 21, the transmission unit setting unit 1162 sets NG as the representative level of the code block #2 because the result of CRC check on the code block #2 in the radio terminal 1002A is NG.

Based on the fact that the representative levels of the code blocks #1 and 4f2 are both NG as shown in FIG. 22(a), the transmission unit setting unit 1162 sets the first transmission unit and the second transmission unit to 6L which is half the packet length of the HARQ packet. Then, the transmission unit setting unit 1162 in the radio base station 1001 extracts from the to-be-transmitted packet #1, 6L of blocks starting from the block after the rear-most block in the blocks that have been transmitted the last time. Similarly, the transmission unit setting unit 1162 in the radio base station 1001 extracts from the to-be-transmitted packet #2, GL of blocks starting from the block after the rear-most block in the blocks that have been transmitted the last time. Then, the radio base station 1001 generates a retransmission HARQ packet #2 having the length 12L by combining the packet of the first transmission unit and the packet of the second transmission unit both of which are of the 6L length blocks and are respectively extracted from the to-be-transmitted packets #1 and #2.

Alternatively, the transmission unit setting unit 1162 in the radio base station 1001 works out the mean level of the communication qualities of the code blocks #1 and #2. To be more concrete, the transmission unit setting unit 1162 works out the mean level using the values 0 and 1 respectively representing OK and NG in the result of the CRC check on the radio terminals 1002A and 1002B. In FIG. 21, the results of the CRC checks on the code block #1 in the radio terminals 1002A and 1002B are both NG. Thus, the transmission unit setting unit 1162 works out (1+1)/2=1 as the mean level of the communication quality of the code block #1. Also in FIG. 21, the results of the CRC checks on the code block #2 in the radio terminals 1002A and 1002B are respectively NG and OK. Thus, the transmission unit setting unit 1162 works out (1+0)/2=0.5 as the mean level of the communication quality of the code block #2.

As shown in FIG. 22(b), the transmission unit setting unit 1162 works out 1:0.5, i.e., 2:1 as the ratio between the first transmission unit and the second transmission unit since the mean level of the communication quality of the code block #1 is 1 and the mean level of the communication quality of the code block #2 is 0.5. Here, the packet length of the HARQ packet is 12L and thus, the transmission unit setting unit 1162 sets the first transmission unit to 8L and the second transmission unit to 4L. Then, the transmission unit setting unit 1162 in the radio base station 1001 extracts from the to-be-transmitted packet #1, 8L of blocks starting from the block after the rear-most block in the blocks that have been transmitted the last time. Similarly, the transmission unit setting unit 1162 in the radio base station 1001 extracts from the to-be-transmitted packet #2, 4L of blocks starting from the block after the rear-most block in the blocks that have been transmitted the last time. Subsequently, the radio base station 1001 combines the packet of the first transmission unit which is blocks of 8L extracted from the to-be-transmitted packet #1 and the packet of the second transmission unit which is blocks of 4L extracted from the to-be-transmitted packet #2, thereby generating the retransmission HARQ packet #2 having the length 12L.

Again, referring back to FIG. 19, the radio base station 1001 determines the radio terminals 1002A and 1002B as the destinations of the retransmission HARQ packet in Step S1108.

Then in Step S1109, the radio base station 1001 simultaneously transmits the same retransmission HARQ packets to the radio terminals 1002A to 1002C set as the destinations through multicast communication. The radio terminals 1002A and 1002B each receive the retransmission HARQ packet.

In Step S1110, the communication quality measurement unit 1258 in each of the radio terminals 1002A and 1002B measures the communication qualities of the code blocks included in the HARQ packet received in Step S1102 and the retransmission HARQ packet received in Step S1109 (CRC recheck).

FIG. 23 is a diagram showing an example of CRC recheck in Step S1110. In the example of FIG. 23, the retransmission HARQ packet #2 is one shown in FIG. 22(a).

As shown in FIG. 23(a1), the communication quality measurement unit 1258 in each of the radio terminals 1002A and 1002B combines the code block #1 and the redundant bits #1 received in Step S1102 with the code block #1 and the redundant bits #1 received in Step S1109. Here, the code block #1 and the redundant bits #1 are each received twice. In this case, the communication quality measurement unit 1258 in each of the radio terminals 1002A to 1002C combines the Euclidean distances of the bit at the same position in the two code blocks #1 and the two redundant bits #1 and determines each bit of the code block #1 and the redundant bits #1 received twice based on the combined values of the Euclidean distances. Further, the communication quality measurement unit 1258 in each of the radio terminals 1002A to 1002C performs CRC recheck on the code block #1 based on the redundant bits #1. Here, the result of the CRC recheck on the code block #1 is OK in both the radio terminals 1002A and 1002B.

Similarly, as shown in FIG. 23(a2), the communication quality measurement unit 1258 in each of the radio terminals 1002A and 1002B combines the code block #2 and the redundant bits #2 received in Step S1102 with the code block #2 and the redundant bits 42 received in Step S1109. Then, the communication quality measurement unit 1258 in each of the radio terminals 1002A to 1002C determines each bit of the code block #2 and the redundant bits #2 received twice. Further, the communication quality measurement unit 1258 in each of the radio terminals 1002A to 1002C performs CRC recheck on the code block #2 based on the redundant bits #2. Here, the result of the CRC recheck on the code block #2 is OK in both the radio terminals 1002A and 1002B.

Again, referring back to FIG. 19, in Step S1111, each of the radio terminals 1002A and 1002B determines whether or not an error is found in any of the code blocks, i.e., determines whether or not all the code blocks are normally received based on the CRC recheck in Step S1110.

Here, as shown in FIG. 23, the results of the CRC checks on the code blocks #1 and #2 are OK in both the radio terminals 1002A and 1002B, and thus all the code blocks are normally received. Then, in Step S1112, the radio terminals 1002A and 1002B transmit ACK and the radio base station 1001 receives the ACK. Thus, the series of operations are completed.

If there is a code block received abnormally, each of the radio terminals 1002A and 1002B transmits NACK and the code block communication qualities to the radio base station 1001 as in Step S1105 again. Then, operations in and after Step S1106 are repeated.

### (3) Advantageous Effect

In the radio communication system 1010 according to the embodiment of the present invention, the radio base station 1001 on the transmitter side generates multiple to-be-transmitted packets each including a code block and redundant bits for error detection. Moreover, the radio base station 1001 generates the HARQ packet by combining the packets of the predetermined transmission units of the respective to-be-transmitted packets and simultaneously transmits the same HARQ packet to the radio terminals 1002A to 1002C through multicast communication.

Each of the radio terminals 1002A to 1002C on the receiver side extracts a packet of a predetermined transmission unit from the to-be-transmitted packet included in the received HARQ packet and performs the CRC check on the code block included in the to-be-transmitted packet based on the redundant bits included in the to-be-transmitted packet. Each of the radio terminals 1002A to 1002C transmits the result of the CRC check as the communication quality of the code block included in the to-be-transmitted packet.

Moreover, the radio base station 1001 sets the retransmission unit for each of the code blocks based on the results of the CRC checks received from the radio terminals 1002A to 1002C. At this point, the radio base station 1001 so sets the transmission units for the to-be-transmitted packets each including the code block where any of the results of the CRC checks received from the radio terminals 1002A to 1002C is NG that the transmission units are the same and the total length of the transmission units is equal to the packet length of the HARQ packet which is fixed. Then, the radio base station 1001 combines the packets of the transmission units extracted from the to-be-transmitted packets to generate the retransmission HARQ packet. Then, the radio base station 1001 transmits the retransmission HARQ packet to a radio terminal that has abnormally received a code block. Furthermore, the radio base station 1001 sets zero as the transmission unit of the to-be-transmitted packet including the code block where the results of the CRC checks received from all the radio terminals 1002A to 1002C are OK. In other words, the radio base station 1001 retransmits no code blocks that have been normally received in all the radio terminals 1002A to 1002C.

Thus, the retransmission unit of a code block varies in accordance with the communication quality of the code block measured by each of the radio terminals 1002A to 1002C. Thus, efficient retransmission control can be achieved.

Moreover, the radio base station 1001 transmits the retransmission HARQ packet only to the radio terminal that has abnormally received the code block. Thus, unnecessary reception process in the radio terminal requiring no retransmission can be prevented from occurring.

### (4) Other Embodiment

As described above, the details of the present invention have been disclosed by using the second embodiment of the present invention. However, it should not be understood that the description and drawings which constitute part of this disclosure limit the present invention. From this disclosure, various alternative embodiments, examples, and operation techniques will be easily found by those skilled in the art.

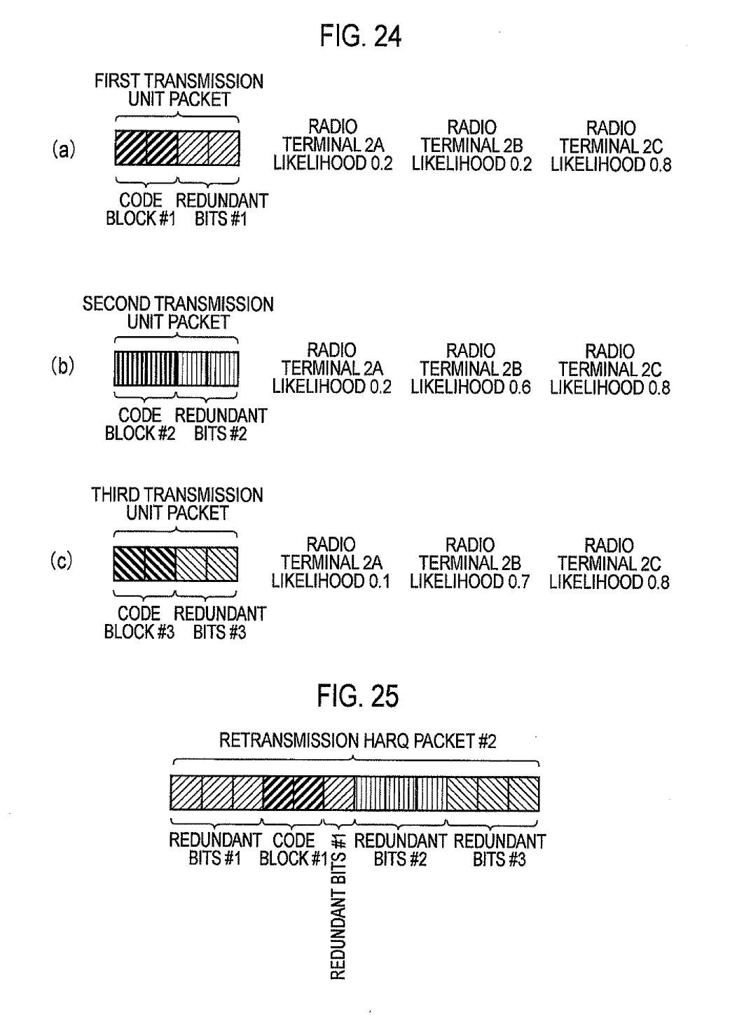

In the above described second embodiment, the communication quality measurement unit 1258 in each of the radio terminals 1002A to 1002C performs CRC check on the code blocks #1 to #3 based on the redundant bits #1 to #3 that are CRC bit sequences. If the redundant bits #1 to #3 are not CRC bit sequences, the communication quality measurement unit 1258 may detect the likelihoods of the code blocks #1 to #3 based on the redundant bits #1 to #3 and use the likelihoods as the communication qualities of the code blocks #1 to #3. FIG. 24 is a diagram showing an example of the likelihood detection for the code blocks #1 to #3.

Moreover, the transmission unit setting unit 1162 in the radio base station 1001 may work out the total values of the likelihoods in the radio terminals 1002A to 1002C for each of the code blocks #1 to #3. Then, the transmission unit setting unit 1162 may so set the first to the third transmission units that the ratio of the first to the third transmission units is based on the inverse of the total values of the likelihood in the code blocks #1 to #3 and the total length of the first to the third transmission units is equal to the packet length of the HARQ packet which is fixed.

For example, it is assumed that a code block is regarded as being normally received in a radio terminal if the likelihood of the code block in the radio terminal is 0.8 or more.

As shown in FIG. 24, regarding the code block #1, the likelihood in the radio terminal 1002A is 0.2, the likelihood in the radio terminal 1002E is 0.2, and the likelihood in the radio terminal 1002C is 0.8. Regarding the code block #2, the likelihood in the radio terminal 1002A is 0.2, the likelihood in the radio terminal 1002E is 0.6, and the likelihood in the radio terminal 1002C is 0.8. Regarding the code block #3, the likelihood in the radio terminal 1002A is 0.1, the likelihood in the radio terminal 1002B is 0.7, and the likelihood in the radio terminal 1002C is 0.8.

In this case, the radio terminal 1002A transmits NACK, the likelihood 0.2 of the code block #1, the likelihood 0.2 of the code block #2, and the likelihood 0.1 of the code block #3 to the radio base station 1001. The radio terminal 1002B transmits NACK, the likelihood 0.2 of the code block #1, the likelihood 0.6 of the code block #2, and the likelihood 0.7 of the code block #3 to the radio base station 1001. The radio terminal 1002C transmits ACK to the radio base station 1101.

The transmission unit setting unit 1162 in the radio base station 1001 works out the total value 0.4 of the likelihood 0.2 of the code block #1 from the radio terminal 1002A and the likelihood 0.2 of the code block #1 from the radio terminal 1002B. Moreover, the transmission unit setting unit 1162 works out the total value 0.8 of the likelihood 0.2 of the code block #2 from the radio terminal 1002A and the likelihood 0.6 of the code block #2 from the radio terminal 1002B. Furthermore, the transmission unit setting unit 1162 works out the total value 0.8 of the likelihood 0.1 of the code block #3 from the radio terminal 1002A and the likelihood 0.7 of the code block #3 from the radio terminal 1002B.

Then, the transmission unit setting unit 1162 sets the ratio of the first transmission unit to the third transmission unit to be the ratio of the inverses of the total values of the likelihoods 1/0.4:1/0.8:1/0.8, and thus the ratio is set to be 2:1:1. Alternatively, the transmission unit setting unit 1162 sets the ratio of the first transmission unit to the third transmission unit to be the ratio of the inverses of the mean values of the likelihoods 1/(0.4/2):1/(0.8/2):1/(0.8/2), and thus the ratio is set to be 2:1:1. Thus, if the length of the HARQ packet is 12L, the first transmission unit is 6L, and the second and the third transmission units are 3L.

Then, the radio base station 1001 generates the retransmission HARQ packet by combining the packet of the first transmission unit of the to-be-transmitted packet #1, the packet of the second transmission unit of the to-be-transmitted packet #2, and the packet of the third transmission unit of the to-be-transmitted packet #3, and transmits the generated retransmission HARQ packet to the radio terminals 1002A and 1002B. FIG. 25 is a diagram showing a configuration of the retransmission HARQ packet with first transmission unit being 6L, and the second and the third transmission units each being 3L.

After receiving the retransmission HARQ packet, the communication quality measurement unit 1258 in the radio terminals 1002A and 1002B measures the communication quality (likelihood redetection) for each of the code blocks included in the pre-received HARQ packet and the newly received retransmission HARQ packet.

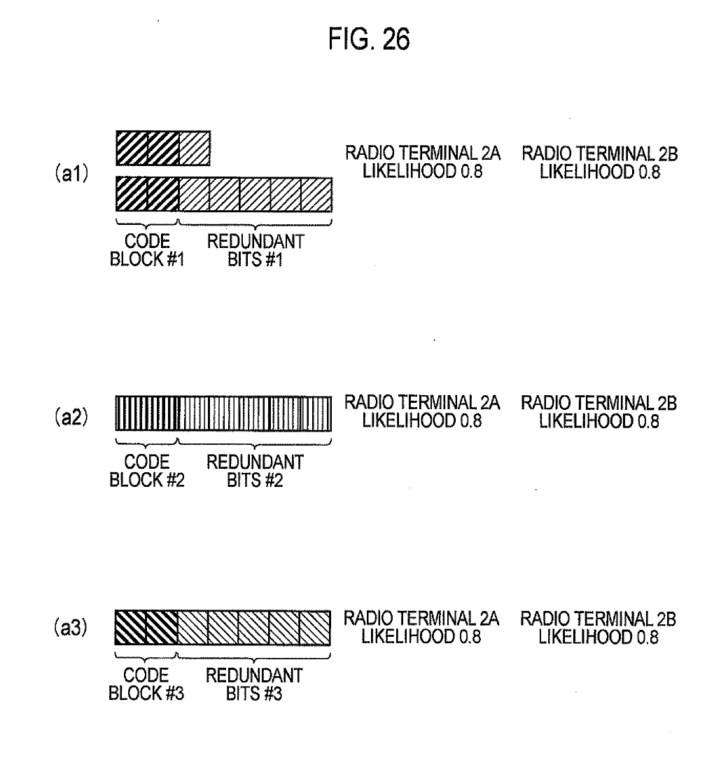

FIG. 26 is a diagram showing an example of likelihood redetection. As shown in FIG. 26(a1), the communication quality measurement unit 1258 in the radio terminals 1002A and 1002B combines the pre-received code block #1 and the redundant bits #1 with the newly received code block #1 and the redundant bits #1. Here, the code block #1 and the redundant bits #1 are both received twice. In this case, the communication quality measurement unit 1258 in the radio terminals 1002A and 1002B combines the Euclidean distances of the bit at the same position in the two code blocks #1 and the two redundant bits #1. The communication quality measurement unit 1258 determines each bit of the code block #1 and the redundant bits #1 received twice based on the combined value of the Euclidean distances. Furthermore, the communication quality measurement unit 1258 in the radio terminals 1002A and 1002B detects the likelihood of the code block #1 based on the redundant bits #1.

In addition, as shown in FIG. 26(a2), the communication quality measurement unit 1258 in the radio terminals 1002A and 1002B combines the pre-received code block #2 and the redundant bits #2 with the newly received redundant bits 4#2 to detect the likelihood of the code block #2 based on the redundant bits #2. Similarly, as shown in FIG. 26(a3), the communication quality measurement unit 1258 in the radio terminals 1002A and 1002B combines the pre-received code block #3 and the redundant bits #3 with the newly received redundant bits #3 to detect the likelihood of the code block #3 based on the redundant bits #3.

Then, each of the radio terminals 1002A and 1002B determines whether or not an error is present in any of the code blocks, i.e., whether or not all the code blocks are received normally, based on the result of the likelihood redetection. For example, in the case of FIG. 26, the likelihood of all the code blocks #1 to #3 is 0.8, and thus all the code blocks are determined to be normally received.

If all the code blocks are normally received, each of the radio terminals 1002A and 1002B transmits ACK and the radio base station 1001 receives the ACK. If there is any code block received abnormally, each of the radio terminals 1002A and 1002B transmits NACK and the likelihood which is the communication qualities of the code blocks.

Moreover, the transmission unit setting unit 1162 in the radio base station 1001 may set the minimum value of the likelihoods in the radio terminals 1002A to 1002C for each of the code blocks #1 to #3 as the representative value. Then, the transmission unit setting unit 1162 may so set the first to the third transmission units that the ratio of the first to the third transmission units is based on the inverse of the representative values of the likelihood in the code blocks #1 to #3 and the total length of the first to the third transmission units is equal to the packet length of the retransmission HARQ packet which is of the fixed length.

In the above described embodiments, the radio communication system employing LTE is described. However, the present invention can be applied to any radio communication systems as long as the radio terminal and the radio base station communicate therein through an uplink communication channel.

As described above, the present invention naturally includes various embodiments which are not described herein. Accordingly, the technical scope of the present invention should be determined only by the matters to define the invention in the scope of claims regarded as appropriate based on the description.

Note that the entire contents of Japanese Patent Application No. 2008-327655 (filed on Dec. 24, 2008) and Japanese Patent Application No. 2009-043169 (filed on Feb. 25, 2009) are incorporated herein by reference.

### INDUSTRIAL APPLICABILITY

As described above, the communication system, the communication apparatuses, the radio base station, and the communication method according to the present invention allow efficient retransmission control based on the communication qualities of the code blocks, and thus are useful for a communication system and the like.

1. A communication system comprising a first communication apparatus and a second communication apparatus, and configured to allow communication of packets each including a plurality of code blocks obtained by dividing a bit sequence, the communication performed between the first communication apparatus and the second communication apparatus, wherein
the first communication apparatus comprises:
a to-be-transmitted packet generation unit configured to generate a plurality of to-be-transmitted packets each having the code block and redundant bits for error detection;
a transmission unit setting unit configured to set a transmission unit for each of the plurality of to-be-transmitted packets;
a first transmission packet generation unit configured to extract a packet of the set transmission unit from each of the plurality of to-be-transmitted packets and combine the packets to generate a first transmission packet; and
a packet transmitter configured to transmit the first transmission packet,
the second communication apparatus comprises:
a packet receiver configured to receive the first transmission packet;
a communication quality measurement unit configured to measure communication qualities of the code blocks respectively included in the packets of the transmission units in the received first transmission packet based on the redundant bits included in each of the packets of the transmission units; and
a communication quality transmitter configured to transmit the measured communication qualities of the code blocks, and
the first communication apparatus further comprises:
a communication quality receiver configured to receive the communication qualities of the code blocks;
a retransmission unit setting unit configured to set a retransmission unit of each of the plurality of to-be-transmitted packets so that a ratio of the retransmission units is based on degradation levels of the received communication qualities of the code blocks;
a second transmission packet generation unit configured to extract a packet of the set retransmission unit from each of the plurality of to-be-transmitted packets and combine the packets to generate a second transmission packet; and
a packet retransmitter configured to transmit the second transmission packet.

2. A communication apparatus configured to communicate, with another communication apparatus, packets each including a plurality of code blocks obtained by dividing a bit sequence, the communication apparatus comprising:
a to-be-transmitted packet generation unit configured to generate a plurality of to-be-transmitted packets each having the code block and redundant bits for error detection;
a transmission unit setting unit configured to set a transmission unit for each of the plurality of to-be-transmitted packets;
a first transmission packet generation unit configured to extract a packet of the set transmission unit from each of the plurality of to-be-transmitted packets and combine the packets to generate a first transmission packet;
a packet transmitter configured to transmit the first transmission packet;
a communication quality receiver configured to receive communication qualities of the code blocks from the other communication apparatus;
a retransmission unit setting unit configured to set a retransmission unit of each of the plurality of to-be-transmitted packets so that a ratio of the retransmission units is based on degradation levels of the received communication qualities of the code blocks;
a second transmission packet generation unit configured to extract a packet of the set retransmission unit from each of the plurality of to-be-transmitted packets and combine the packets to generate a second transmission packet; and
a packet retransmitter configured to transmit the second transmission packet.

3. The communication apparatus according to claim 2, wherein
the communication quality receiver receives a result of error detection on each of the code blocks in the other communication apparatus, and
the retransmission unit setting unit sets zero as the retransmission unit of the to-be-transmitted packet including a code block where the result of the error detection indicates that there is no error, and sets a positive value as the retransmission unit of the to-be-transmitted packet including a code block where the result of the error detection indicates that there is an error.

4. The communication apparatus according to claim 2, wherein
the communication quality receiver receives a likelihood of each of the code blocks in the other communication apparatus, and
the retransmission unit setting unit sets the retransmission units of the to-be-transmitted packets so that the ratio of the retransmission units is based on the inverse of the likelihoods.

5. The communication apparatus according to claim 2, further comprising
a notification receiver configured to receive an abnormal notification or a normal notification from the other communication apparatus, the abnormal notification indicating that the code block is not normally received, the normal notification indicating that the code block is normally received, wherein
the packet retransmitter transmits the second transmission packet when the abnormal notification is received or no normal notification is received within a predetermined period of time after the transmission performed by the packet transmitter.

6. A communication apparatus configured to communicate, with another communication apparatus, packets each including a plurality of code blocks obtained by dividing a bit sequence, the communication apparatus comprising:
a packet receiver configured to receive a transmission packet in the case where the other communication apparatus transmits the transmission packet, the transmission packet generated by the other communication apparatus by: extracting a packet of a predetermined transmission unit from each of a plurality of to-be-transmitted packets each including the code block and redundant bits for error detection; and combining the packets of the predetermined transmission units;
a communication quality measurement unit configured to measure communication qualities of the code blocks respectively included in the packets of the predetermined transmission units based on the redundant bits respectively included in the packets of the predetermined transmission units in the received transmission packet; and
a communication quality transmitter configured to transmit the measured communication qualities of the code blocks.

7. The communication apparatus according to claim 6, wherein the communication quality measurement unit acquires a result of error detection on each of the code blocks.

8. The communication apparatus according to claim 6, wherein the communication quality measurement unit acquires a likelihood of each of the code blocks.

9. The communication apparatus according to claim 6, further comprising
a notification transmitter configured to transmit a notification indicating that the code blocks are not normally received or a notification indicating that the code blocks are normally received, based on the measured communication qualities of the code blocks.

10. A communication method in a communication system including a first communication apparatus and a second communication apparatus, and allowing communication of packets each including a plurality of code blocks obtained by dividing a bit sequence, the communication performed between the first communication apparatus and the second communication apparatus, the communication method comprising the steps of:
generating, by the first communication apparatus, a plurality of to-be-transmitted packets each having the code block and redundant bits for error detection;
setting, by the first communication apparatus, a transmission unit for each of the plurality of to-be-transmitted packets;
extracting, by the first communication apparatus, a packet of the set transmission unit from each of the plurality of to-be-transmitted packets and combining the packets to generate a first transmission packet;
transmitting the first transmission packet by the first communication apparatus;
receiving the first transmission packet by the second communication apparatus;
measuring, by the second communication apparatus, communication qualities of the code blocks included in each of the packets of the transmission units in the received first transmission packet based on the redundant bits included in the packet of the transmission unit;
transmitting the measured communication qualities of the code blocks by the second communication apparatus;
receiving the communication qualities of the code blocks by the first communication apparatus;
setting, by the first communication apparatus, a retransmission unit of each of the plurality of to-be-transmitted packets so that a ratio of the retransmission units is based on degradation levels of the received communication qualities of the code blocks;
extracting, by the first communication apparatus, a packet of the set retransmission unit from each of the plurality of to-be-transmitted packets and combining the packets to generate a second transmission packet; and
transmitting the second transmission packet by the first communication apparatus.

11. A communication system comprising a radio base station and a plurality of radio terminals, and configured to simultaneously send the plurality of radio terminals packets each including a plurality of code blocks obtained by dividing a bit sequence indicating the same information from the radio base station, wherein the radio base station comprises:
a to-be-transmitted packet generation unit configured to generate a plurality of
to-be-transmitted packets each having the code block and redundant bits for error detection;
a transmission unit setting unit configured to set a transmission unit for each of the plurality of to-be-transmitted packets;
a first transmission packet generation unit configured to extract a packet of the set transmission unit from each of the plurality of to-be-transmitted packets and combine the packets to generate a first transmission packet; and
a packet transmitter configured to transmit the first transmission packet to the plurality of radio terminals,
the plurality of radio terminals each comprises:
a packet receiver configured to receive the first transmission packet from the radio base station;
a communication quality measurement unit configured to measure communication qualities of the code blocks respectively included in the packets of the transmission units in the received first transmission packet based on the redundant bits respectively included in the packets of the transmission units; and
a communication quality transmitter configured to transmit the measured communication qualities of the code blocks to the radio base station,
the radio base station comprises:
a communication quality receiver configured to receive the communication qualities of the code blocks from the plurality of radio terminals;
a retransmission unit setting unit configured to set a retransmission unit of each of the plurality of to-be-transmitted packets so that a ratio of the retransmission units is based on degradation levels of the communication qualities of the code blocks received from the plurality of radio terminals;
a second transmission packet generation unit configured to extract a packet of the set retransmission unit from each of the plurality of to-be-transmitted packets and combine the packets to generate a second transmission packet; and
a packet retransmitter configured to transmit the second transmission packet to the plurality of radio terminals, and
the plurality of radio terminals each further comprise a retransmission packet receiver configured to receive the second transmission packet from the radio base station.

12. A radio base station configured to simultaneously send a plurality of radio terminals packets each including a plurality of code blocks obtained by dividing a bit sequence of the same information, the radio base station comprising:
a to-be-transmitted packet generation unit configured to generate a plurality of to-be-transmitted packets each having the code block and redundant bits for error detection;
a transmission unit setting unit configured to set a transmission unit for each of the plurality of to-be-transmitted packets;
a first transmission packet generation unit configured to extract a packet of the set transmission unit from each of the plurality of to-be-transmitted packets and combine the packets to generate a first transmission packet;
a packet transmitter configured to transmit the first transmission packet to the plurality of radio terminals;
a communication quality receiver configured to receive communication qualities of the code blocks from the plurality of radio terminals;
a retransmission unit setting unit configured to set a retransmission unit of each of the plurality of to-be-transmitted packets so that a ratio of the retransmission units is based on degradation levels of the communication qualities of the code blocks received from the plurality of radio terminals;
a second transmission packet generation unit configured to extract a packet of the set retransmission unit from each of the plurality of to-be-transmitted packets and combine the packets to generate a second transmission packet; and
a packet retransmitter configured to transmit the second transmission packet to the plurality of radio terminals.

13. The radio base station according to claim 12, wherein the retransmission unit setting unit sets the retransmission units of the plurality of to-be-transmitted packets so that a ratio of the retransmission units is based on a degradation level of at least one of a mean level and a representative level of the communication qualities of each of the code blocks received from the plurality of radio terminals.

14. The radio base station according to claim 12, wherein
the communication quality receiver receives a result of error detection on each of the code blocks in the plurality of radio terminals, and
the retransmission unit setting unit sets a positive value as the retransmission unit of the to-be-transmitted packet including the code block where the result of the error detection indicating that there is an error in at least one of the plurality of radio terminals.

15. The radio base station according to claim 12, wherein
the communication quality receiver receives a likelihood of each of the code blocks in the plurality of radio terminals, and
the retransmission unit setting unit sets a positive value as the retransmission unit of the to-be-transmitted packet including the code block where the likelihood is smaller than a predetermined value in at least one of the plurality of radio terminals.

16. The radio base station according to claim 12, further comprising a notification receiver configured to receive an abnormal notification or a normal notification from each of the plurality of radio terminals, the abnormal notification indicating that not all the code blocks in the first transmission packets are normally received, the normal notification indicating that all the code blocks in the first transmission packets are normally received, wherein
the packet retransmitter transmits the second transmission packet when the abnormal notification is received from any one of the plurality of radio terminals, or the normal notification is not received from any one of the plurality of radio terminals within a predetermined period of time after the transmission performed by the packet transmitter.

17. The radio base station according to claim 16, further comprising a destination setting unit configured to set destinations of the second transmission packet when the normal notification is received from any one of the plurality of radio terminals, by setting as the destinations the radio terminals other than the radio terminal that has transmitted the normal notification.

18. A communication method in a communication system including a radio base station and a plurality of radio terminals, and configured to simultaneously send the plurality of radio terminals packets each including a plurality of code blocks obtained by dividing a bit sequence indicating the same information from the radio base station, the communication method comprising the steps of:
generating, by the radio base station, a plurality of to-be-transmitted packets each having the code block and redundant bits for error detection;
setting, by the radio base station, a transmission unit for each of the plurality of to-be-transmitted packets;
extracting, by the radio base station, a packet of the set transmission unit from each of the plurality of to-be-transmitted packets and combining the packets to generate a first transmission packet;
transmitting the first transmission packet to the plurality of radio terminals by the radio base station;
receiving the first transmission packet from the radio base station by the plurality of radio terminals;
measuring, by the plurality of radio terminals, communication qualities of the code blocks respectively included in the packets of the transmission units in the received first transmission packet based on the redundant bits included in each of the packets of the transmission units;
transmitting the measured communication qualities of the code blocks to the radio base station by the plurality of radio terminals;
receiving the communication qualities of the code blocks from the plurality of radio terminals by the radio base station;
setting, by the radio base station, a retransmission unit of each of the plurality of to-be-transmitted packets so that a ratio of the retransmission units is based on degradation levels of the communication qualities of the code blocks received from the plurality of radio terminals;
extracting, by the radio base station, a packet of the set retransmission unit from each of the plurality of to-be-transmitted packets and combining the packets to generate a second transmission packet;
transmitting the second transmission packet to the plurality of radio terminals by the radio base station; and
receiving the second transmission packet from the radio base station by the plurality of radio terminals.
